(19) United States
(12) Patent Application Publication
(10) Pub. No.: US 2026/0214262 A1
(43) Pub. Date: Jul. 23, 2026

(54) Methods and Apparatus of Motion Shift in Overlapped Blocks Motion Compensation for Video Coding

(71) Applicant: MEDIATEK INC., Hsinchu City (TW)

(72) Inventors: Yu-Cheng LIN, Hsinchu City (TW); Chih-Hsuan LO, Hsinchu City (TW); Chen-Yen LAI, Hsinchu City (TW); Man-Shu CHIANG, Hsinchu City (TW); Tzu-Der CHUANG, Hsinchu City (TW); Chih-Wei HSU, Hsinchu City (TW); Ching-Yeh CHEN, Hsinchu City (TW); Yi-Wen CHEN, San Jose, CA (US); Yu-Wen HUANG, Hsinchu City (TW)

(21) Appl. No.: 19/141,209

(22) PCT Filed: Dec. 14, 2023
(86) PCT No.: PCT/CN2023/138723

§ 371 Date: Jun. 19, 2025

Related U.S. Application Data
(60) Provisional application No. 63/479,745, filed on Jan. 13, 2023.
(60) Provisional application No. 63/480,332, filed on Jan. 18, 2023.
(60) Provisional application No. 63/501,695, filed on May 12, 2023.
(60) Provisional application No. 63/513,128, filed on Jul. 12, 2023.

(51) Int. Cl. H04N 19/583; H04N 19/11; H04N 19/176

(52) U.S. Cl. CPC H04N 19/583; H04N 19/11; H04N 19/176

(57) ABSTRACT

A method and apparatus for video coding using OBMC for IBC or IntraTMP coded blocks. According to the method, input data comprising a current block/subblock and a neighbouring block/subblock are received. Whether a target block/subblock is coded in IBC (Intra Block Copy) mode or IntraTMP (Intra Template Matching Prediction) mode is determined, wherein the target block/subblock corresponds to any one of the current block/subblock and the neighbouring block/subblock. In response to the target block/subblock being coded in the IBC mode or the IntraTMP mode, OBMC (Overlapped Block Motion Compensation) process is applied to a boundary region of the current block/subblock by generating samples in the boundary region using a target BV (Block Vector) of the target block/subblock coded in the IBC mode or a target motion shift of the target block/subblock coded in the IntraTMP mode.

### CROSS REFERENCE TO RELATED APPLICATIONS

The present invention is a non-Provisional Application of and claims priority to U.S. Provisional Patent Application No. 63/479,745, filed on Jan. 13, 2023, U.S. Provisional Patent Application No. 63/480,332, filed on Jan. 18, 2023, U.S. Provisional Patent Application No. 63/501,695, filed on May 12, 2023 and U.S. Provisional Patent Application No. 63/513,128, filed on Jul. 12, 2023. The U.S. Provisional Patent Applications are hereby incorporated by reference in their entireties.

### FIELD OF THE INVENTION

The present invention relates to video coding system using Overlapped Block Motion Compensation (OBMC). In particular, the present invention relates to OBMC for blocks coded in Intra Block Copy (IBC) mode or Intra Template Matching Prediction (IntraTMP) mode.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously encoded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Overlapped Block Motion Compensation (OBMC)

Overlapped Block Motion Compensation (OBMC) is to find a Linear Minimum Mean Squared Error (LMMSE) estimate of a pixel intensity value based on motion-compensated signals derived from its nearby block motion vectors (MVs). From estimation-theoretic perspective, these MVs are regarded as different plausible hypotheses for its true motion, and to maximize coding efficiency, their weights should minimize the mean squared prediction error subject to the unit-gain constraint.

When High Efficient Video Coding (HEVC) was developed, several proposals were made using OBMC to provide coding gain. Some of them are described as follows.

In JCTVC-C251 (Peisong Chen, et. al., “Overlapped block motion compensation in TMuC”, Joint Collaborative Team on Video Coding (JCT-VC) of ITU-T SG16 WP3 and ISO/IEC JTC1/SC29/WG11, 3rd Meeting: Guangzhou, CN, 7-15 Oct. 2010, Document: JCTVC-C251), OBMC was applied to geometry partition. In geometry partition, it is very likely that a transform block contains pixels belonging to different partitions. In geometry partition, since two different motion vectors are used for motion compensation, the pixels at the partition boundary may have large discontinuities that can produce visual artefacts similar to blockiness. This in turn decreases the transform efficiency. Let the two regions created by a geometry partition be denoted by region 1 and region 2. A pixel from region 1 (2) is defined to be a boundary pixel if any of its four connected neighbours (left, top, right, and bottom) belongs to region 2 (1). FIG. 2 shows an example where grey-dotted pixels belong to the boundary of region 1 (grey region) and white-dotted pixels belong to the boundary of region 2 (white region). If a pixel is a boundary pixel, the motion compensation is performed using a weighted sum of the motion predictions from the two motion vectors. The weights are 3/4 for the prediction using the motion vector of the region containing the boundary pixel and 1/4 for the prediction using the motion vector of the other region. The overlapping boundaries improve the visual quality of the reconstructed video while also providing BD-rate gain.

In JCTVC-F299 (Liwei Guo, et. al., “CE2: Overlapped Block Motion Compensation for 2N×N and N×2N Motion Partitions”, Joint Collaborative Team on Video Coding (JCT-VC) of ITU-T SG16 WP3 and ISO/IEC JTC1/SC29/WG11, 6th Meeting: Torino, 14-22 Jul. 2011, Document: JCTVC-F299), OBMC was applied to symmetrical motion partitions. If a coding unit (CU) is partitioned into 2 2N×N or N×2N prediction units (PUs), OBMC is applied to the horizontal boundary of the two 2N×N prediction blocks, and the vertical boundary of the two N×2N prediction blocks. Since those partitions may have different motion vectors, the pixels at partition boundaries may have large discontinuities, which may generate visual artefacts and also reduce the transform/coding efficiency. In JCTVC-F299, OBMC is introduced to smooth the boundaries of motion partition.

FIGS. 3A-B illustrate an example of OBMC for 2N×N (FIG. 3A) and N×2N blocks (FIG. 3B). The grey pixels are pixels belonging to Partition 0 and white pixels are pixels belonging to Partition 1. The overlapped region in the luma component is defined as 2 rows (columns) of pixels on each side of the horizontal (vertical) boundary. For pixels which are 1 row (column) apart from the partition boundary, i.e., pixels labelled as A in FIGS. 3A-B, OBMC weighting factors are (3/4, 1/4). For pixels which are 2 rows (columns) apart from the partition boundary, i.e., pixels labelled as B in FIGS. 3A-B, OBMC weighting factors are (7/8, 1/8). For chroma components, the overlapped region is defined as 1 row (column) of pixels on each side of the horizontal (vertical) boundary, and the weighting factors are (3/4, 1/4).

Currently, the OBMC is performed after normal MC, and BIO is also applied in these two MC processes, separately. That is, the MC results for the overlapped region between two CUs or PUs is generated by another process not in the normal MC process. BIO (Bi-Directional Optical Flow) is then applied to refine these two MC results. This can help to skip the redundant OBMC and BIO processes, when two neighbouring MVs are the same. However, the required bandwidth and MC operations for the overlapped region is increased compared to integrating OBMC process into the normal MC process. For example, the current PU size is 16×8, the overlapped region is 16×2, and the interpolation filter in MC is 8-tap. If the OBMC is performed after normal MC, then we need (16+7)×(8+7)+(16+7)×(2+7)=552 reference pixels per reference list for the current PU and the related OBMC. If the OBMC operations are combined with normal MC into one stage, then only (16+7)×(8+2+7)=391 reference pixels per reference list for the current PU and the related OBMC. Therefore, in the following, in order to reduce the computation complexity or memory bandwidth of BIO, several methods are proposed, when BIO and OBMC are enabled simultaneously.

In the JEM (Joint Exploration Model), the OBMC is also applied. In the JEM, unlike in H.263, OBMC can be switched on and off using syntax at the CU level. When OBMC is used in the JEM, the OBMC is performed for all motion compensation (MC) block boundaries except for the right and bottom boundaries of a CU. Moreover, it is applied to both the luma and chroma components. In the JEM, a MC block corresponds to a coding block. When a CU is coded with sub-CU mode (includes sub-CU merge, affine and FRUC mode), each sub-block of the CU is a MC block. To process CU boundaries in a uniform fashion, OBMC is performed at sub-block level for all MC block boundaries, where sub-block size is set equal to 4×4, as illustrated in FIGS. 4A-B.

When OBMC is applied to the current sub-block, besides current motion vectors, motion vectors of four connected neighbouring sub-blocks, if available and are not identical to the current motion vector, are also used to derive the prediction block for the current sub-block. These multiple prediction blocks based on multiple motion vectors are combined to generate the final prediction signal of the current sub-block. Prediction block based on motion vectors of a neighbouring sub-block is denoted as PNn, with n indicating an index for the neighbouring above, below, left and right sub-blocks and prediction block based on motion vectors of the current sub-block is denoted as PC. FIG. 4A illustrates an example of OBMC for sub-blocks of the current CU 410 using a neighbouring above sub-block (i.e., PN1), left neighbouring sub-block (i.e., PN2), left and above sub-blocks i.e., PN3). FIG. 4B illustrates an example of OBMC for the ATMVP mode, where block PN uses MVs from four neighbouring sub-blocks for OBMC. When PN is based on the motion information of a neighbouring sub-block that contains the same motion information as the current sub-block, the OBMC is not performed from PN. Otherwise, every sample of PN is added to the same sample in PC, i.e., four rows/columns of PN are added to PC. The weighting factors {1/4, 1/8, 1/16, 1/32} are used for PN and the weighting factors {3/4, 7/8, 15/16, 31/32} are used for PC. The exception are small MC blocks (i.e., when height or width of the coding block is equal to 4 or a CU is coded with sub-CU mode), for which only two rows/columns of PN are added to PC. In this case, weighting factors {1/4, 1/8} are used for PN and weighting factors {3/4, 7/8} are used for PC. For PN generated based on motion vectors of vertically (horizontally) neighbouring sub-block, samples in the same row (column) of PN are added to PC with a same weighting factor.

In the JEM, for a CU with size less than or equal to 256 luma samples, a CU level flag is signalled to indicate whether OBMC is applied or not for the current CU. For the CUs with size larger than 256 luma samples or not coded with the AMVP mode, OBMC is applied by default. At the encoder, when OBMC is applied for a CU, its impact is taken into account during the motion estimation stage. The prediction signal formed by OBMC using motion information of the top neighbouring block and the left neighbouring block is used to compensate the top and left boundaries of the original signal of the current CU, and then the normal motion estimation process is applied.

In JEM (Joint Exploration Model for VVC development), the OBMC is applied. For example, as shown in FIG. 5, for a current block 510, if the above block and the left block are coded in an inter mode, it takes the MV of the above block to generate an OBMC block A and takes the MV of the left block to generate an OBMC block L. The predictors of OBMC block A and OBMC block L are blended with the current predictors. To reduce the memory bandwidth of OBMC, it is proposed to do the above 4-row MC and left 4-column MC with the neighbouring blocks. For example, when doing the above block MC, 4 additional rows are fetched to generate a block of (above block+OBMC block A). The predictors of OBMC block A are stored in a buffer for coding the current block. When doing the left block MC, 4 additional columns are fetched to generate a block of (left block+OBMC block L). The predictors of OBMC block L are stored in a buffer for coding the current block. Therefore, when doing the MC of the current block, four additional rows and four additional columns of reference pixels are fetched to generate the predictors of the current block, the OBMC block B, and the OBMC block R as shown in FIG. 6A (may also generate the OBMC block BR as shown in FIG. 6B). The OBMC block B and the OBMC block R are stored in buffers for the OBMC process of the bottom neighbouring blocks and the right neighbouring blocks.

For an M×N block, if the MV is not integer and a 8-tap interpolation filter is applied, a reference block with size of (M+7)×(N+7) is used for motion compensation. However, if the BIO and OBMC is applied, additional reference pixels are required, which increases the worst case memory bandwidth.

### Template Matching Based OBMC

Recently, a template matching-based OBMC scheme has been proposed (JVET-Y0076) to the emerging international coding standard. As shown in FIG. 7, for each top block with a size of 4×4 at the top CU boundary, the above template size equals to 4×1. In FIG. 7, box 710 corresponds to a CU. If N adjacent blocks have the same motion information, then the above template size is enlarged to 4N×1 since the MC operation can be processed at one time, which is in the same manner in ECM-OBMC. For each left block with a size of 4×4 at the left CU boundary, the left template size equals to 1×4 or 1×4N.

For each 4×4 top block (or N 4×4 blocks group), the prediction value of boundary samples is derived according to the following steps:
Take block A as the current block and its above neighbouring block AboveNeighbour_A for example. The operation for left blocks is conducted in the same manner.
First, three template matching costs (Cost1, Cost2, Cost3) are measured by SAD between the reconstructed samples of a template and its corresponding reference samples derived by MC process according to the following three types of motion information:

Cost1 is calculated according to A's motion information.

Cost2 is calculated according to AboveNeighbour_A's motion information.

Cost3 is calculated according to weighted prediction of A's and AboveNeighbour_A's motion information with weighting factors as 3/4 and 1/4 respectively.
Second, choose one out of three approaches to calculate the final prediction results of boundary samples by comparing Cost1, Cost2 and Cost 3.

The original MC result using current block's motion information is denoted as Pixel1, and the MC result using neighbouring block's motion information is denoted as Pixel2. The final prediction result is denoted as NewPixel.
If Cost1 is minimum, then NewPixel(i,j)=Pixel1(i,j).
If (Cost2+(Cost2>>2)+(Cost2>>3))<=Cost1, then blending mode 1 is used.

For luma blocks, the number of blending pixel rows is 4.

$$NewPixel ( i , 0 ) = ( 26 \times Pixel 1 ( i , 0 ) + 6 \times Pixel 2 ( i , 0 ) + 16 ) ≫ 5$$

$$NewPixel ( i , 1 ) = ( 7 \times Pixel 1 ( i , 1 ) + Pixel 2 ( i , 1 ) + 4 ) ≫ 3$$

$$NewPixel ( i , 2 ) = ( 15 \times Pixel 1 ( i , 2 ) + Pixel 2 ( i , 2 ) + 8 ) ≫ 4$$

$$NewPixel ( i , 3 ) = ( 31 \times Pixel 1 ( i , 3 ) + Pixel 2 ( i , 3 ) + 16 ) ≫ 5$$

For chroma blocks, the number of blending pixel rows is 1.

$$NewPixel ( i , 0 ) = ( 26 \times Pixel 1 ( i , 0 ) + 6 \times Pixel 2 ( i , 0 ) + 16 ) ≫ 5$$

If Cost1<=Cost2, then blending mode 2 is used.

For luma blocks, the number of blending pixel rows is 2.

$$NewPixel ( i , 0 ) = ( 15 \times Pixel 1 ( i , 0 ) + Pixel 2 ( i , 0 ) + 8 ) ≫ 4$$

$$NewPixel ( i , 1 ) = ( 31 \times Pixel 1 ( i , 1 ) + Pixel 2 ( i , 1 ) + 16 ) ≫ 5$$

For chroma blocks, the number of blending pixel rows/columns is 1.

$$NewPixel ( i , 0 ) = ( 15 \times Pixel 1 ( i , 0 ) + Pixel 2 ( i , 0 ) + 8 ) ≫ 4$$

Otherwise, blending mode 3 is used.

For luma blocks, the number of blending pixel rows is 4.

$$NewPixel ( i , 1 ) = ( 7 \times Pixel 1 ( i , 1 ) + Pixel 2 ( i , 1 ) + 4 ) ≫ 3$$

$$NewPixel ( i , 2 ) = ( 15 \times Pixel 1 ( i , 2 ) + Pixel 2 ( i , 2 ) + 8 ) ≫ 4$$

$$NewPixel ( i , 3 ) = ( 31 \times Pixel 1 ( i , 3 ) + Pixel 2 ( i , 3 ) + 16 ) ≫ 5$$

For chroma blocks, the number of blending pixel rows is 1.

$$NewPixel ( i , 0 ) = ( 7 \times Pixel 1 ( i , 0 ) + Pixel 2 ( i , 0 ) + 4 ) ≫ 3$$

### Intra Block Copy (IBC) Mode

Motion Compensation, one of the key technologies in hybrid video coding, explores the pixel correlation between adjacent pictures. It is generally assumed that, in a video sequence, the patterns corresponding to objects or background in a frame are displaced to form corresponding objects in the subsequent frame or correlated with other patterns within the current frame. With the estimation of such displacement (e.g. using block matching techniques), the pattern can be mostly reproduced without the need to re-code the pattern. Similarly, block matching and copy has also been tried to allow selecting the reference block from the same picture as the current block. It was observed to be inefficient when applying this concept to camera captured videos. Part of the reasons is that the textual pattern in a spatial neighbouring area may be similar to the current coding block, but usually with some gradual changes over the space. It is difficult for a block to find an exact match within the same picture in a video captured by a camera. Accordingly, the improvement in coding performance is limited.

However, the situation for spatial correlation among pixels within the same picture is different for screen contents. For a typical video with texts and graphics, there are usually repetitive patterns within the same picture. Hence, intra (picture) block compensation has been observed to be very effective. A new prediction mode, i.e., the intra block copy (IBC) mode or called current picture referencing (CPR), has been introduced for screen content coding to utilize this characteristic. In the CPR mode, a prediction unit (PU) is predicted from a previously reconstructed block within the same picture. Further, a displacement vector (called block vector or BV) is used to indicate the relative displacement from the position of the current block to that of the reference block. The prediction errors are then coded using transformation, quantization and entropy coding. An example of CPR compensation is illustrated in FIG. 8, where block 812 is a corresponding block for block 810, and block 822 is a corresponding block for block 820. In this technique, the reference samples correspond to the reconstructed samples of the current decoded picture prior to in-loop filter operations, both deblocking and sample adaptive offset (SAO) filters in HEVC.

The very first version of CPR was proposed in JCTVC-M0350 (Budagavi et al., AHG8: Video coding using Intra motion compensation, Joint Collaborative Team on Video Coding (JCT-VC) of ITU-T SG16 WP3 and ISO/IEC JTC 1/SC 29/WG11, 13th Meeting: Incheon, KR, 18-26 Apr. 2013, Document: JCTVC-M0350) to the HEVC Range Extensions (RExt) development. In this version, the CPR compensation was limited to be within a small local area, with only 1-D block vector and only for block size of 2N×2N. Later, a more advanced CPR design has been developed during the standardization of HEVC SCC (Screen Content Coding).

### Intra Template Matching Prediction (IntraTMP) Mode

Intra template matching prediction (IntraTMP) is a special intra prediction mode that copies the best prediction block from the reconstructed part of the current frame, whose L-shaped template matches the current template. For a predefined search range, the encoder searches for the most similar template matched with the current template in a reconstructed part of the current frame and uses the corresponding block as a prediction block. The encoder then signals the usage of this mode, and the same prediction operation is performed at the decoder side.

The prediction signal is generated by matching the L-shaped causal neighbour of the current block with another block in a predefined search area in FIG. 2 consisting of:
R1: current CTU
R2: top-left CTU
R3: above CTU
R4: left CTU

In FIG. 9, the current block 910 in R1 is matched with the corresponding block 912 in R2. The templates for the current block and the matched block are shown as darker-colour L-shaped areas. Area 922 corresponds to reconstructed region in the current picture 920. Sum of absolute differences (SAD) is used as a cost function. Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW ,$$

$$SearchRange\_h = a * BlkH .$$

Where ‘a’ is a constant that controls the gain/complexity trade-off. In practice, ‘a’ is equal to 5.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min (BlkW, BlkH)/2.

The Intra template matching tool is enabled for CUs with size less than or equal to 64 in width and height. This maximum CU size for Intra template matching is configurable.

The Intra template matching prediction mode is signalled at CU level through a dedicated flag when DIMD (Decoder-side Intra Mode Derivation) is not used for the current CU.

### IntraTMP Derived Block Vector Candidates for IBC

In this method, block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

Intra TMP block vector is stored in the IBC block vector buffer and, the current IBC block can use both IBC BV and IntraTMP BV of neighbouring blocks as BV candidates for IBC BV candidate list as shown in FIG. 10.

In FIG. 10, block 1010 corresponds to the current block and block 1012 corresponds to a neighbouring IntraTMP block. The IntraTMP BV 1016 is used to locate the best matching block 1022 according to the matching cost between template 1024 and template 1014. Area 1022 corresponds to reconstructed region in the current picture 1030. IntraTMP block vectors are added to IBC block vector candidate list as spatial candidates.

### JVET-AA0070 EE2-3.2: Reconstruction-Reordered IBC for Screen Content Coding

In JVET-AA0070 (Zhipin Deng, et al., “EE2-3.2: Reconstruction-Reordered IBC for screen content coding”, Joint Video Exploration Team (JVET) of ITU-T SG 16 WP 3 and ISO/IEC JTC 1/SC 29/WG 11, 27th Meeting, by teleconference, 13-22 Jul. 2022, Document: JVET-AA0070), a scheme for reconstruction-reordered IBC for screen content coding is disclosed. According to JVET-AA0070, symmetry is often observed in video content, especially in text character regions and computer-generated graphics in screen content sequences. In JVET-Z0159 (Zhipin Deng, et al., “Non-EE2: Reconstruction-Reordered IBC for screen content coding”, Joint Video Exploration Team (JVET) of ITU-T SG 16 WP 3 and ISO/IEC JTC 1/SC 29/WG 11, 26th Meeting, by teleconference, 20-29 Apr. 2022, Document: JVET-Z0159), a Reconstruction-Reordered IBC (RRIBC) mode was proposed for screen content video coding to further improve the coding efficiency of IBC in the ECM.

When RRIBC is applied, the samples in a reconstruction block are flipped according to the flip type of the current block. At the encoder side, the original block is flipped before motion search and residual calculation, while the prediction block is derived without flipping. At the decoder side, the reconstruction block is flipped back to restore the original block.

Specifically, two flip methods, horizontal flip and vertical flip, are supported for RRIBC coded blocks. A syntax flag is firstly signalled for an IBC AMVP coded block, indicating whether the reconstruction is flipped; and if it is flipped, another flag is further signalled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signalled and inferred to be equal to 0. Similarly, the horizontal component of the BV is not signalled and inferred to be equal to 0 when a vertical flip is applied.

To better utilize the symmetry property, a flip-aware BV adjustment approach is applied to refine the block vector candidate. For example, as shown in FIG. 11A and FIG. 11B, (x_{nbr}, y_{nbr}) and (x_{cur}, y_{cur}) represent the coordinates of the center sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbT}ₕ) in case that the neighbouring block is coded with a horizontal flip (as shown in FIG. 11A), i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip (as shown in FIG. 11B, i.e., BV^{cur}ᵥ=2(y_{nbr}−y_{cur})+BV^{nbr}ᵥ.

### JVET-AC0059 AHG12: TMP Using Reconstruction-Reordered for Screen Content Coding (RR-TMP)

In JVET-AC0059 (Jung-Kyung Lee, et al., “AHG12: TMP using Reconstruction-Reordered for screen content coding (RR-TMP)”, Joint Video Exploration Team (JVET) of ITU-T SG 16 WP 3 and ISO/IEC JTC 1/SC 29/WG 11, 29th Meeting, by teleconference, 11-20 Jan. 2023, Document: JVET-AC0059), Reconstruction-Reordered TMP is proposed for screen content video coding. When RR-TMP is applied, both the encoder and decoder search for the most similar template to the flipped current template in a predefined search range, which is a reconstructed part of the current frame. The corresponding block is flipped according to flip type, horizontal or vertical flip, and used as a prediction block.

In contrast with the regular TMP, the search regions for RR-TMP are constrained. For the horizontal flip type, only a portion of the current CTU (R1) and left region (R4) are explored. Regarding the vertical flip mode, only a portion of the current CTU (R1) and the above region (R3) are explored.

The dimensions of search regions, search range width (SRW), and search range height (SRH), are set proportional to the block dimension, which is 5 times of block dimension (CbHeight, CbWidth) as shown in FIG. 12A for the horizontal flip and FIG. 12B for the vertical flip.

IBC Merge Mode with Block Vector Differences (IBC-MBVD)

Affine-MMVD and GPM-MMVD have been adopted to ECM as an extension of regular MMVD mode.

It is natural to extend the MMVD mode to the IBC merge mode.

In IBC-MBVD, the distance set is {1—pel, 2—pel, 4—pel, 8—pel, 12-pel, 16—pel, 24—pel, 32—pel, 40—pel, 48—pel, 56—pel, 64—pel, 72—pel, 80-pel, 88—pel, 96—pel, 104—pel, 112—pel, 120—pel, 128—pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbour block.

### IBC-LIC

In JVET-AC0112 (Yang Wang, et al., “EE2-3.6: IBC-CIIP, IBC-GPM, and IBC-LIC”, Joint Video Exploration Team (JVET) of ITU-T SG 16 WP 3 and ISO/IEC JTC 1/SC 29/WG 11, 29th Meeting, by teleconference, 11-20 Jan. 2023, Document: JVET-AC0112), IBC-LIC is adopted in ECM. Intra block copy with local illumination compensation (IBC-LIC) is a coding tool which compensates the local illumination variation within a picture between the CU coded with IBC and its prediction block with a linear equation. The parameters of the linear equation are derived same as LIC for inter prediction except that the reference template is generated using block vector in IBC-LIC. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

IBC-GPM

In JVET-AC0112, IBC-GPM is adopted in ECM. Intra block copy with geometry partitioning mode (IBC-GPM) is a coding tool which divides a CU into two sub-partitions geometrically. The prediction signals of the two sub-partitions are generated using IBC and intra prediction. IBC-GPM can be applied to regular IBC merge mode or IBC TM merge mode. An intra prediction mode (IPM) candidate list is constructed using the same method as GPM with inter and intra prediction for intra prediction, and the IPM candidate list size is pre-defined as 3. There are 48 geometry partitioning modes in total, which are divided into two geometry partitioning mode sets as follows:

TABLE 1
Geometry partitioning modes in the first
geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 2
Geometry partitioning modes in the second
geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When IBC-GPM is used, an IBC-GPM geometry partitioning mode set flag is signalled to indicate whether the first or the second geometry partitioning mode set is selected, followed by the geometry partitioning mode index. An IBC-GPM intra flag is signalled to indicate whether intra prediction is used for the first sub-partition. When intra prediction is used for a sub-partition, an intra prediction mode index is signalled. When IBC is used for a sub-partition, a merge index is signalled.

### IBC-CHIP

In JVET-AC0112, IBC-CIIP is adopted in ECM. Combined intra block copy and intra prediction (IBC-CIIP) is a coding tool for a CU which uses IBC with merge mode and intra prediction to obtain two prediction signals, and the two prediction signals are weighted summed to generate the final prediction. Specifically, if the intra prediction is planar or DC mode, the final prediction is obtained as follows:

$$P = ( {W}_{ibc} \times {P}_{ibc} + ( ( 1 ≪ shift ) - {W}_{ibc} ) \times {P}_{intra} + ( 1 ≪ shift - 1 ) ) ) ≫ shift$$

wherein P_{ibc} and Pᵢₙₜᵣₐ denote the IBC prediction signal and intra prediction signal, respectively. (W_{ibc} shift) are set equal to (13, 4) and (1, 1) for IBC merge mode and IBC AMVP mode.

### JVET-AD0193 EE2-2.11e: Adaptive OBMC Control

JVET-AD0193 (Kai Cui, et al., “EE2-2.11e: Adaptive OBMC control”, Joint Video Exploration Team (JVET) of ITU-T SG 16 WP 3 and ISO/IEC JTC 1/SC 29/WG 11, 30th Meeting, Antalya, TR, 21-28 Apr. 2023, 11-20 Jan. 2023, Document: JVET-AD0193) proposes modifications to Overlapped Block Motion Compensation (OBMC). The proposed modifications include the following aspects:

1) OBMC flag is inherited from a neighbouring affine block for affine merge mode.

2) OBMC is not applied to a block if there is a neighbour block coded with IBC, palette, or

BDPCM modes.

3) When applying OBMC to a block, block boundary check regarding whether OBMC is applied to the boundary is further made based on the reference samples of the current block. If any absolute difference between the prediction sample and non-interpolated (integer pel) reference sample is greater than a threshold, the OBMC is not applied to that boundary.

OBMC is applied to boundaries of inter coded blocks to reduce the visual degradation at the boundaries due to coding errors. In the present invention, a new OBMC scheme is disclosed for blocks coded in IBC or IntraTMP mode to reduce the artefacts at boundaries of IBC or IntraTMP coded blocks.

### BRIEF SUMMARY OF THE INVENTION

A method and apparatus for video coding using OBMC for IBC or IntraTMP coded blocks are disclosed. According to the method, input data comprising a current block/subblock and a neighbouring block/subblock are received. Whether a target block/subblock is coded in IBC (Intra Block Copy) mode or IntraTMP (Intra Template Matching Prediction) mode is determined, wherein the target block/subblock corresponds to any one of the current block/subblock and the neighbouring block/subblock. In response to the target block/subblock being coded in the IBC mode or the IntraTMP mode, OBMC (Overlapped Block Motion Compensation) process is applied to a boundary region of the current block/subblock by generating samples in the boundary region using a target BV (Block Vector) of the target block/subblock coded in the IBC mode or a target motion shift of the target block/subblock coded in the IntraTMP mode.

In one embodiment, when the target block/subblock corresponds to the neighbouring block/subblock coded in the IBC mode, the target BV, a horizontal component of the target BV or a vertical component of the target BV is used for the OBMC process. In one embodiment, the target block/subblock corresponds to the current block/subblock coded in the IBC mode.

In one embodiment, when the target block/subblock corresponds to the neighbouring block/subblock coded in the IBC mode, an average BV is used for the OBMC process, and wherein the average BV corresponds to an average of the target BV and a current MV (Motion Vector) of the current block/subblock.

In one embodiment, when the target block/subblock corresponds to the neighbouring block/subblock coded in the IntraTMP mode, the target motion shift, a horizontal component of the target motion shift or a vertical component of the target motion shift is used for the OBMC process.

In one embodiment, when the target block/subblock corresponds to the neighbouring block/subblock coded in the IntraTMP mode, an average motion shift is used for the OBMC process, and wherein the average motion shift corresponds to an average of the target motion shift and a current MV (Motion Vector) of the current block/subblock.

In one embodiment, when the target block/subblock corresponds to the current block/subblock coded in the IBC mode, and the neighbouring block/subblock is coded in an inter-prediction mode, the target BV and motion vector of the neighbouring block/subblock are used for the OBMC process.

In one embodiment, when the target block/subblock corresponds to the current block/subblock coded in the IntraTMP mode, and the neighbouring block/subblock is coded in an inter-prediction mode, the target motion shift and motion vector of the neighbouring block/subblock are used for the OBMC process.

In one embodiment, when the target block/subblock corresponds to the neighbouring block/subblock coded in the IBC mode, and the current block/subblock is coded in an inter-prediction mode, the target BV and motion vector of the current block/subblock are used for the OBMC process.

In one embodiment, when the target block/subblock corresponds to the neighbouring block/subblock coded in the IntraTMP mode, and the current block/subblock is coded in an inter-prediction mode, the target motion shift and motion vector of the current block/subblock are used for the OBMC process.

In one embodiment, when the target block/subblock corresponds to the current block/subblock coded in the IBC mode, and the neighbouring block/subblock is coded in the IntraTMP mode, the target BV and motion shift of the neighbouring block/subblock are used for the OBMC process.

In one embodiment, when the target block/subblock corresponds to the current block/subblock coded in the IntraTMP mode, and the neighbouring block/subblock is coded in the IBC mode, the target motion shift and block vector of the neighbouring block/subblock are used for the OBMC process.

In one embodiment, when both the current block/subblock and the neighbouring block/subblock are coded in the IBC mode, both block vectors of the current block/subblock and the neighbouring block/subblock are used for the OBMC process.

In one embodiment, when both the current block/subblock and the neighbouring block/subblock are coded in the IntraTMP mode, both motion shifts of the current block/subblock and the neighbouring block/subblock are used for the OBMC process.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates an example of overlapped motion compensation for geometry partitions.

FIGS. 3A-B illustrate an example of OBMC for 2N×N (FIG. 3A) and N×2N blocks (FIG. 3B).

FIG. 4A illustrate an example of the sub-blocks that OBMC is applied, where the example includes subblocks at a CU/PU boundary.

FIG. 4B illustrate an example of the sub-blocks that OBMC is applied, where the example includes subblocks coded in the AMVP mode.

FIG. 5 illustrate an example of the OBMC processing using neighbouring blocks from above and left for the current block.

FIG. 6A illustrate an example of the OBMC processing for the right and bottom part of the current block using neighbouring blocks from right and bottom.

FIG. 6B illustrate an example of the OBMC processing for the right and bottom part of the current block using neighbouring blocks from right, bottom and bottom-right.

FIG. 7 illustrates an example of Template Matching based OBMC where, for each top block with a size of 4×4 at the top CU boundary, the above template size equals to 4×1.

FIG. 8 illustrates an example of current picture referencing for Intra Block Copy (IBC) prediction mode.

FIG. 9 illustrates an example of search area used for Intra Template Matching Prediction (IntraTMP).

FIG. 10 illustrates an example of the use of IntraTMP block vector for IBC block.

FIG. 11A illustrates an example of BV adjustment for horizontal flip.

FIG. 11B illustrates an example of BV adjustment for vertical flip.

FIG. 12A illustrates an example of Reconstruction-Reordered TMP for horizontal flip.

FIG. 12B illustrates an example of Reconstruction-Reordered TMP adjustment for vertical flip.

FIG. 13 illustrates an example of OBMC with IBC mode predicted and IntraTMP mode predicted neighbouring blocks.

FIG. 14 illustrates an example of the top reference block and region for the reconstruction-reordered OBMC when the reconstruction-reordered OBMC is enabled.

FIG. 15 illustrates an example of the left reference block and region for the reconstruction-reordered OBMC when the reconstruction-reordered OBMC is enabled.

FIGS. 16A-D illustrate examples of neighbouring motion references at the current block for four different BV values.

FIGS. 17A-D illustrate examples of neighbouring motion references at the current subblock for four different BV values.

FIGS. 18A-C illustrate examples of reference template of neighbouring motion at the current block for out-of-picture boundary check.

FIGS. 18D-F illustrate examples of reference template of neighbouring motion at the current subblock for out-of-picture boundary check.

FIGS. 19A-C illustrate examples of reference template of current motion at the current block for out-of-picture boundary check.

FIGS. 19D-F illustrate examples of reference template of current motion at the current subblock for out-of-picture boundary check.

FIG. 20 illustrates an example of using neighbouring IMV or neighbouring interpolation filter information to generate a neighbouring predictor.

FIG. 21 illustrates a flowchart of an exemplary video coding system, where the OBMC process is applied to boundaries of IBC or IntraTMP coded blocks according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

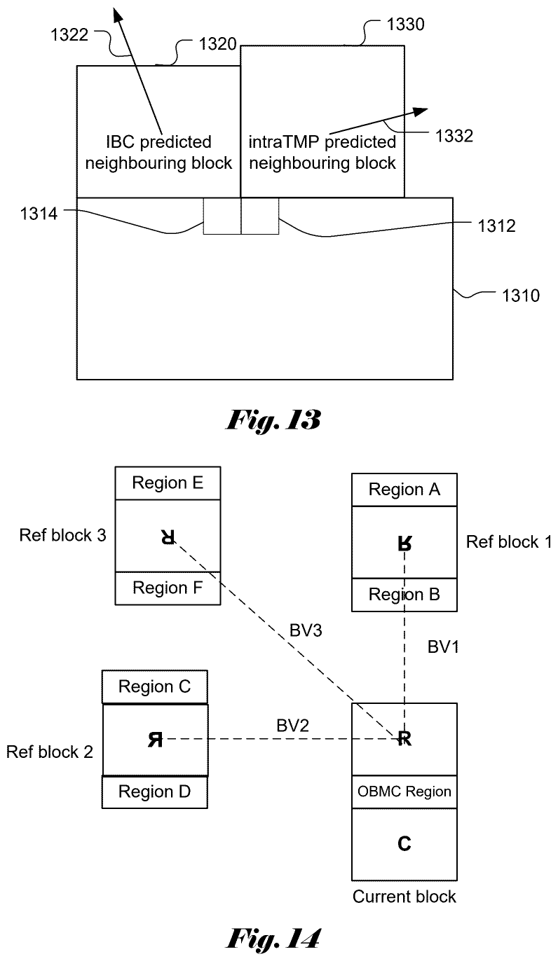

In the present invention, conventionally, when the current block or neighbouring block is coded in IBC mode or IntraTMP mode, the OBMC process will be skipped. A new method of motion shift in OBMC is proposed. In the proposed method, when a neighbouring block or the current block is coded with IBC or IntraTMP mode, the OBMC process will be performed, using the block vectors (BV) from IBC mode or the motion shift from IntraTMP, as shown in FIG. 13. In FIG. 13, neighbouring block 1320 of the current block 1310 is coded in IBC mode with BV 1322 and neighbouring block 1330 of the current block 1310 is coded in intraTMP mode with BV 1332. Boxes 1312 and 1314 are two subblocks.

### Derivation of BV and Motion Shift in OBMC

In the proposed method, when the current block or neighbouring block is coded with IBC mode or IntraTMP mode, the BV or the motion shift from template matching can be used in the OBMC process.

In one embodiment, when a neighbouring block is coded with IBC mode, the BV is used in OBMC at the current block.

In another embodiment, when a neighbouring block is coded with IBC mode, only the horizontal or vertical component of BV is used in OBMC for the current block.

In another embodiment, when the neighbouring block is coded with IBC mode, the averaged BV (from the current block's MV and neighbouring block's BV) is used in OBMC for the current block.

In another embodiment, when the neighbouring block is coded with IntraTMP mode, the motion shift derived in template matching is used in OBMC for the current block.

In another embodiment, when the neighbouring block is coded with IntraTMP mode, only the horizontal or vertical motion shift derived in template matching is used in OBMC at current block.

In another embodiment, when the neighbouring block is coded with IBC mode, the averaged motion shift (from current block's MV and neighbouring block's motion shift derived from template matching) is used in OBMC at current block.

In another embodiment, when current block is coded with IBC mode and neighbouring block is inter-prediction mode, OBMC is applied to the current block, using the MV from a neighbouring block and the BV from the current block.

In another embodiment, when current block is coded with IntraTMP mode and neighbouring block is inter-prediction mode, OBMC is applied to the current block, using the MV from neighbouring block and motion shift from current block.

In another embodiment, when the current block is coded with inter-prediction mode and neighbouring block is IBC mode, OBMC is applied to the current block, using the MV from the current block and BV from neighbouring block.

In another embodiment, when the current block is coded with inter-prediction mode and a neighbouring block is IntraTMP mode, OBMC is applied to the current block, using the MV from the current block and motion shift from neighbouring block.

In another embodiment, when the current block is coded with IBC mode and neighbouring block is IntraTMP mode, OBMC is applied to the current block, using the motion shift from neighbouring block and BV from current block.

In another embodiment, when the current block is coded with IntraTMP mode and a neighbouring block is IBC mode, OBMC is applied to the current block, using BV from neighbouring block and BV from current block.

In another embodiment, when both current block and neighbouring block are coded with IntraTMP mode, OBMC is applied to the current block, using motion shifts from a neighbouring block and from the current block.

In another embodiment, when both the current block and neighbouring block are coded with IBC mode, OBMC is applied to the current block, using BVs from a neighbouring block and from the current block.

### Bandwidth Constraint in OBMC

Conventionally, in consideration of bandwidth in OBMC, when a neighbouring block is a bi-prediction CU, the MV used in OBMC will be converted into uni-prediction. Or when a neighbouring block uses fractional MV, the MV used in OBMC will be converted into integer MV. In the proposed method, when the neighbouring CU or current CU is coded in IntraTMP mode or IBC mode, the conversion from bi-prediction to uni-prediction is not performed or is skipped or the conversion from fractional MV to integer MV is not performed or is skipped.

In one embodiment, when a neighbouring block is coded with IBC mode, the BV used in OBMC can be bi-prediction and there is no bi-prediction to uni-prediction conversion.

In another embodiment, when the neighbouring block is coded with IntraTMP mode, the motion shift derived from template matching and used in OBMC can be bi-prediction and there is no bi-prediction to uni-prediction conversion

In another embodiment, when the neighbouring block is coded with IBC mode, the BV used in OBMC can be fractional and there is no fractional to integer conversion.

In another embodiment, when the neighbouring block is coded with IntraTMP mode, the motion shift derived from template matching and used in OBMC can be fractional and there is no fractional to integer conversion.

In another embodiment, when the neighbouring block is coded with IBC mode, only the horizontal or vertical BV used in OBMC can be bi-prediction and there is no bi-prediction to uni-prediction conversion.

In another embodiment, when the neighbouring block is coded with IntraTMP mode, only the horizontal or vertical motion shift derived from template matching and used in OBMC can be bi-prediction and there is no bi-prediction to uni-prediction conversion.

In another embodiment, when the neighbouring block is coded with IBC mode, only the horizontal or vertical BV used in OBMC can be fractional and there is no fractional to integer conversion.

In another embodiment, when the neighbouring block is coded with IntraTMP mode, only the horizontal or vertical motion shift derived from template matching and used in OBMC can be fractional and there is no fractional to integer conversion.

In another embodiment, when the current block is coded with IBC mode, the BV used in OBMC can be bi-prediction and there is no bi-prediction to uni-prediction conversion.

In another embodiment, when the current block is coded with IntraTMP mode, the motion shift derived from template matching and used in OBMC can be bi-prediction and there is no bi-prediction to uni-prediction conversion.

In another embodiment, when the current block is coded with IBC mode, the BV used in OBMC can be fractional and there is no fractional to integer conversion.

In another embodiment, when the current block is coded with Intra TMP mode, the motion shift derived from template matching and used in OBMC can be fractional and there is no fractional to integer conversion.

In another embodiment, when the current block is coded with IBC mode, only the horizontal or vertical BV used in OBMC can be bi-prediction and there is no bi-prediction to uni-prediction conversion.

In another embodiment, when the current block is coded with IntraTMP mode, only the horizontal or vertical motion shift derived from template matching and used in OBMC can be bi-prediction and there is no bi-prediction to uni-prediction conversion.

In another embodiment, when the current block is coded with IBC mode, only the horizontal or vertical BV used in OBMC can be fractional and there is no fractional to integer conversion.

In another embodiment, when the current block is coded with IntraTMP mode, only the horizontal or vertical motion shift derived from template matching and used in OBMC can be fractional and there is no fractional to integer conversion.

### OBMC Weighting Used in IBC and IntraTMP

In the proposed method, when the current block or neighbouring block is coded with IBC or IntraTMP modes, the OBMC weighting used can be different from other inter-prediction modes OBMC process.

In one embodiment, when the neighbouring block is coded with IBC mode, the OBMC weighting used in CU-boundary OBMC or subblock-boundary OBMC is different from the neighbouring block coded with inter-prediction mode OBMC.

In another embodiment, when the neighbouring block is coded with IntraTMP mode, the OBMC weighting used in CU-boundary OBMC or subblock-boundary OBMC is different from the neighbouring block coded with inter-prediction mode OBMC.

In another embodiment, when the current block is coded with IBC mode, the OBMC weighting used in CU-boundary OBMC or subblock-boundary OBMC is different from the neighbouring block coded with inter-prediction mode OBMC.

In another embodiment, when the current block is coded with IntraTMP mode, the OBMC weighting used in CU-boundary OBMC or subblock-boundary OBMC is different from the neighbouring block coded with inter-prediction mode OBMC.

In another embodiment, when the neighbouring block is coded with IBC mode, the OBMC weighting used in CU-boundary OBMC or subblock-boundary OBMC is different from the current block coded with inter-prediction mode OBMC.

In another embodiment, when the neighbouring block is coded with IntraTMP mode, the OBMC weighting used in CU-boundary OBMC or subblock-boundary OBMC is different from the current block coded with inter-prediction mode OBMC.

In another embodiment, when the current block is coded with IBC mode, the OBMC weighting used in CU-boundary OBMC or subblock-boundary OBMC is different from the current block coded with inter-prediction mode OBMC.

In another embodiment, when the current block is coded with IntraTMP mode, the OBMC weighting used in CU-boundary OBMC or subblock-boundary OBMC is different from the current block coded with inter-prediction mode OBMC.

### Template-Matching-Based OBMC in IBC and IntraTMP

In the proposed method, when the current block or neighbouring block is coded with IBC mode or IntraTMP mode, template-matching-based OBMC can also be applied.

In one embodiment, when the neighbouring block is coded with IBC mode, the template-matching-based OBMC can also be applied, using the BV from neighbouring block to generate template.

In another embodiment, when the neighbouring block is coded with IntraTMP mode, the template-matching-based OBMC can also be applied, using the motion shift from neighbouring IntraTMP block to generate template.

In another embodiment, when the current block is coded with IBC mode, the template-matching-based OBMC can also be applied, using the BV from the current block to generate template.

In another embodiment, when the current block is coded with IntraTMP mode, the template-matching-based OBMC can also be applied, using the motion shift from current Intra TMP block to generate template.

### High-Level Syntax and Flag Control of OBMC in IBC and IntraTMP

In the proposed method, when the current block or neighbouring block is coded with IBC mode or IntraTMP mode, a high-level flag is signalled to decide if OBMC is enabled or not. The high-level flag can be SPS flag, PPS flag, frame-level flag or block-level flag. The flag can be signalled or sometimes to be inferred under some conditions.

In one embodiment, when the neighbouring block is coded with IBC mode, the condition of applying OBMC at current block or not depends on high-level flag, such as SPS flag, PPS flag, frame-level flag or block-level flag.

In another embodiment, when the neighbouring block is coded with IntraTMP mode, the condition of applying OBMC at current block or not depends on high-level flag, such as SPS flag, PPS flag, frame-level flag or block-level flag.

In another embodiment, when the current block is coded with IBC mode, the condition of applying OBMC at current block or not depends on high-level flag, such as SPS flag, PPS flag, frame-level flag or block-level flag.

In another embodiment, when the current block is coded with IntraTMP mode, the condition of applying OBMC at current block or not depends on high-level flag, such as SPS flag, PPS flag, frame-level flag or block-level flag.

In another embodiment, when the current block is coded with IBC mode, the condition of using neighbouring MV in inter-prediction modes or BV in IBC mode or motion shift in IntraTMP mode in OBMC or not depends on high-level flag, such as SPS flag, PPS flag, frame-level flag or block-level flag.

In another embodiment, when the current block is coded with IntraTMP mode, the condition of using neighbouring MV in inter-prediction modes or BV in IBC mode or motion shift in IntraTMP mode in OBMC or not depends on high-level flag, such as SPS flag, PPS flag, frame-level flag or block-level flag.

In another embodiment, when the neighbouring block is coded with IBC mode or IntraTMP mode, the high-level flag is signalled but can also be inferred according to some conditions, such as block width, block height, block area, aspect ratio, BVs threshold or motion shifts threshold.

In another embodiment, when the current block is coded with IBC mode or

IntraTMP mode, the high-level flag is signalled but can also be inferred according to some conditions, such as block width, block height, block area, aspect ratio, BVs threshold or motion shifts threshold.

In another embodiment, high-level flag is signalled but it can also be overwritten by some conditions, such as block width, block height, block area, block aspect ratio, or signalled threshold. If the difference between two predictors is greater than the signalled threshold, disable OBMC implicitly.

In another embodiment, high-level flag is signalled but it can also be overwritten by some conditions, such as block width, block height, block area, aspect ratio, BVs threshold or motion shifts threshold or pre-defined threshold. The pre-defined threshold can be the variance value of predictor luma samples or mean value of predictor luma samples. If the variance value of predictor luma samples is greater than pre-defined value or mean value of predictor luma samples is greater than pre-defined value, disable OBMC implicitly.

In the present invention, conventionally, a new method of OBMC in reconstruction reordered IBC (RR-IBC) and reconstruction reordered IntraTMP (RR-IntraTMP) is proposed. In the proposed method, when blocks are coded with IBC mode or IntraTMP mode, reconstruction-reordered process may be enabled and whether to apply OBMC will depend on some conditions, such as flip type, reordering direction, differences between predicted and reference samples.

In one embodiment, when blocks are coded with IBC mode or IntraTMP mode, when the reconstruction-reordered process is horizontal flip, top boundary OBMC is disabled or skipped. The left boundary OBMC may apply according to some conditions, such as block size, block characteristics, BV, motion shift or differences between predicted and reference samples.

In another embodiment, when blocks are coded with IBC mode or Intra TMP mode, when the reconstruction-reordered process is vertical flip, left boundary OBMC is disabled or skipped. The top boundary OBMC may apply according to some conditions, such as block size, block characteristics, BV, motion shift or difference between predictor and reference samples.

In another embodiment, when blocks are coded with IBC mode or Intra TMP mode, when the reconstruction-reordered process is horizontal and vertical flip, OBMC is disabled or skipped.

In another embodiment, when blocks are coded with IBC mode or IntraTMP mode, when the reconstruction-reordered process is enabled, OBMC is applied but constrained to use non-reordered reference samples.

### Reconstruction Reordered OBMC (RR-OBMC)

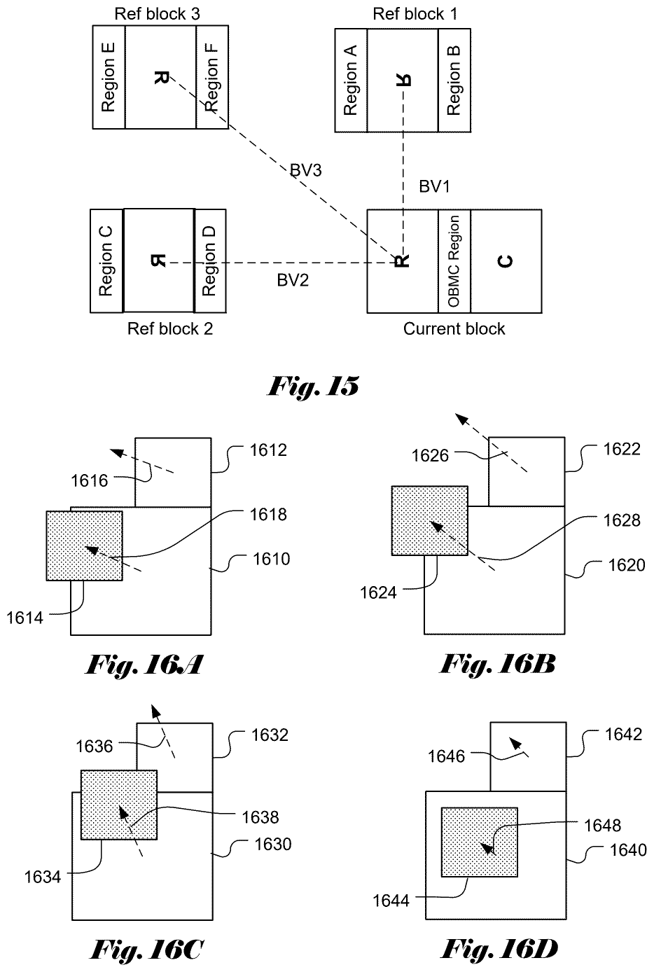

In the proposed method, for blocks coded with IBC mode or Intra-TMP mode, RR-OBMC is applied to the current block or subblock boundary, as shown in FIG. 14 and FIG. 15. The flip type or flip direction in reconstruction-reordered OBMC can be horizontal flip, vertical flip or a combination thereof.

In one embodiment, as shown in FIG. 14, for blocks coded with IBC mode or IntraTMP mode, RR-OBMC may apply at OBMC region, using Region A or Region B or a combination of Region A and Region B as reference samples when flip type or flip direction in reconstruction-reordered OBMC is vertical flip.

In another embodiment, as shown in FIG. 14, for blocks coded with IBC mode or IntraTMP mode, RR-OBMC may apply to OBMC region, using Region C or Region D or a combination of Region C and Region D as reference samples when flip type or flip direction in reconstruction-reordered OBMC is horizontal flip.

In another embodiment, as shown in FIG. 14, for blocks coded with IBC mode or IntraTMP mode, RR-OBMC may be applied to OBMC region, using Region E or Region F or a combination of Region E and Region F as reference samples when flip type or flip direction in reconstruction-reordered OBMC is vertical and horizontal flip.

In another embodiment, as shown in FIG. 15, for blocks coded with IBC mode or Intra TMP mode, RR-OBMC may be applied to OBMC region, using Region A or Region B or a combination of Region A and Region B as reference samples when flip type or flip direction in reconstruction-reordered OBMC is vertical flip.

In another embodiment, as shown in FIG. 15, for blocks coded with IBC mode or IntraTMP mode, RR-OBMC may be applied to OBMC region, using Region C or Region D or a combination of Region C and Region D as reference samples when flip type or flip direction in reconstruction-reordered OBMC is horizontal flip.

In another embodiment, as shown in FIG. 15, for blocks coded with IBC mode or IntraTMP mode, RR-OBMC may be applied to OBMC region, using Region E or Region F or a combination of Region E and Region F as reference samples when flip type or flip direction in reconstruction-reordered OBMC is vertical and horizontal flip.

In another embodiment, for blocks coded with IBC mode or IntraTMP mode, RR-OBMC may be applied to OBMC region, and the regions used in OBMC can be determined based on difference between predictor and reference samples. If difference between predictor and the reference sample in the region (e.g. Region A or Region B) is smaller than a threshold, the region is used in OBMC.

In another embodiment, for blocks coded with IBC mode or IntraTMP mode, RR-OBMC may be applied to OBMC region, and the regions used in OBMC can be determined based on difference between predictor and reference samples. If difference between predictor and the reference sample in the region (e.g. Region A or Region B) is larger than a threshold, the region is used in OBMC.

In another embodiment, for blocks coded with IBC mode or IntraTMP mode, RR-OBMC is applied or not depends on difference between predictor and reference samples in different regions. For example, in FIG. 14, difference between predictor and Region A and difference between predictor and Region B are calculated as DiffA and DiffB, respectively. If DiffA is larger than DiffB, RR-OBMC is applied, using Region A as reference samples.

In another embodiment, for blocks coded with IBC mode or IntraTMP mode, RR-OBMC is applied or not depends on difference between predictor and reference samples in different regions. For example, in FIG. 14, difference between predictor and Region A and difference between predictor and Region B are calculated as DiffA and DiffB, respectively. If DiffA is smaller than DiffB, RR-OBMC is applied, using Region A as reference samples.

In another embodiment, for blocks coded with IBC mode or IntraTMP mode, RR-OBMC is applied or not depends on difference between predictor and reference samples in different regions. For example, in FIG. 15, difference between predictor and Region C and difference between predictor and Region D are calculated as DiffC and DiffD, respectively. If DiffC is larger than DiffD, RR-OBMC is applied, using Region C as reference samples.

In another embodiment, for blocks coded with IBC mode or IntraTMP mode, RR-OBMC is applied or not depends on difference between predictor and reference samples in different regions. For example, in FIG. 14 and FIG. 15, difference between predictor and FIG. 14 Region A, FIG. 14 Region B, FIG. 15 Region C and FIG. 15 Region D are calculated as DiffA, DiffB, DiffC, DiffD, respectively. If DiffA plus DiffC is smaller than DiffB plus DiffD, RR-OBMC is applied, using Region A and Region C as reference samples.

In another embodiment, for blocks coded with IBC mode or IntraTMP mode, RR-OBMC is applied or not depends on difference between predictor and reference samples in different regions. For example, in FIG. 14 and FIG. 15, difference between predictor and FIG. 14 Region A, FIG. 14 Region B, FIG. 15 Region C and FIG. 15 Region D are calculated as DiffA, DiffB, DiffC, DiffD, respectively. If DiffA plus DiffC is smaller than DiffB plus DiffD, RR-OBMC is applied, using Region A and Region C as reference samples.

In another embodiment, for blocks coded with IBC mode or IntraTMP mode, RR-OBMC is applied to one boundary or not depends on difference between predictor and reference samples in different regions.

For example, in FIG. 14 and FIG. 15, difference between predictor and FIG. 14 Region A, FIG. 14 Region B, FIG. 15 Region C and FIG. 15 Region D are calculated as DiffA, DiffB, DiffC, DiffD, respectively. Each boundary will determine the RR-OBMC or not accordingly the difference independently.

OBMC Blending from Inter-Prediction Mode and IBC Mode and IntraTMP Mode

In the proposed method, for blocks coded with IBC mode or IntraTMP mode or inter-prediction modes, when OBMC is applied to the current block or subblock, neighbouring blocks or subblocks coded with IBC mode or IntraTMP mode or inter-prediction modes are considered during blending process.

In one embodiment, for blocks coded with IBC mode or IntraTMP mode, neighbouring blocks coded with IBC mode or IntraTMP mode or inter-prediction modes are considered during OBMC blending process.

In another embodiment, for blocks coded with IBC mode, only neighbouring blocks coded with IBC mode or inter-prediction modes are allowed during OBMC blending process.

In another embodiment, for blocks coded with IBC mode, only neighbouring blocks coded with IBC mode are allowed during OBMC blending process.

In another embodiment, for blocks coded with inter-prediction modes, only neighbouring blocks coded with IBC mode or inter-prediction modes are allowed during OBMC blending process.

### Exclusiveness of OBMC and Reconstruction-Reordered in IBC Mode and Intra-TMP Mode

In the proposed method, for blocks coded with IBC mode or IntraTMP mode, when reconstruction-reordered OBMC is applied, OBMC is disabled. Or when reconstruction-reordered OBMC is not applied, OBMC may be applied to current blocks. The applying condition of OBMC may only depend on reconstruction-reordered flag, or depends on reconstruction-reordered flag and other conditions, such as difference between predictor and reconstruction.

In one embodiment, for blocks coded with IBC mode or IntraTMP mode, when reconstruction-reordered OBMC is applied, OBMC is disabled. OBMC and reconstruction-reordered are mutually exclusive.

In another embodiment, for blocks coded with IBC mode or IntraTMP mode, when reconstruction-reordered OBMC is applied, OBMC is conditionally disabled at some boundaries. For example, when horizontal flip is applied, OBMC at left or right boundary is disabled. Another example is when vertical flip is applied, OBMC at top or bottom boundary is disabled.

In another embodiment, for blocks coded with IBC mode or IntraTMP mode, when reconstruction-reordered OBMC is applied, OBMC is conditionally disabled. When difference between flipped or not flipped predictor and flipped or not flipped reconstruction exceeds a threshold, OBMC is disabled. The predefined threshold can be explicitly signalled in SPS/PPS/PH/SH or implicitly derived. (e.g. according to slice type, QP, and so on.)

In another embodiment, for blocks coded with IBC mode or IntraTMP mode, when reconstruction-reordered OBMC is applied, OBMC is conditionally disabled. When difference between flipped or not flipped predictor and flipped or not flipped reconstruction is smaller than a threshold, OBMC is disabled. The predefined threshold can be explicitly signalled in SPS/PPS/PH/SH or implicitly derived. (e.g. according to slice type, QP, and so on.)

In the present invention, a new method of neighbouring motion condition in OBMC is disclosed. When the neighbouring block is IBC coded block or IntraTMP coded block, OBMC and TM-based OBMC is applied to the current block using the neighbouring motion with motion condition check. The motion condition check includes, but not limited to, reference region validity check, out-of-picture boundary check, current block region validity check and so on.

In ECM OBMC, OBMC is always performed in original domain, no matter LMCS is enabled or not. In the proposed method, OBMC can be performed in an original domain or reshaped domain, if LMCS is enabled. The decision of applying in the original domain or reshaped domain can depend on slice type, prediction mode type, high-level flag or syntax control, and so on.

In ECM OBMC, when a neighbouring block is in intra-prediction mode or in IBC mode, OBMC process is skipped for the current subblock or current block. In the proposed method, when the neighbouring block is in IBC mode or IntraTMP mode, OBMC process is not skipped, but some kinds of motion in IBC mode or IntraTMP mode may not be allowed in OBMC.

In ECM OBMC, consecutive same neighbouring motions will be grouped together to perform template-matching-based OBMC, resulting in same blending lines decision for consecutive subblocks. In the proposed method, each subblock may have its own blending lines or weighting decision.

### Neighbouring Motion Reference Region Validity Check

When the neighbouring block is IBC coded or IntraTMP coded, OBMC and TM-based OBMC is applied with the neighbouring motion for reference region validity check. When any motion referencing current picture is used in OBMC process, the motion should be valid in IBC reference region or IntraTMP search region.

In one embodiment, when the neighbouring motion is used in OBMC process, the reference samples and reference template should be in the allowed current block's reference region, such as current block's IBC reference region or current block's IntraTMP reference region.

In another embodiment, when the neighbouring motion is used in OBMC process and only vertical part of reference samples exceeds allowed current block's reference region, horizontal motion component is used in OBMC process.

In another embodiment, when the neighbouring motion is used in OBMC process and only horizontal part of reference samples exceeds allowed current block's reference region, vertical motion component is used in OBMC process.

In another embodiment, when motion from IntraTMP mode is used in OBMC process, motion should be valid in IBC reference region.

In another embodiment, when motion from IBC mode is used in OBMC process, motion should be valid in IntraTMP search region.

In another embodiment, reference sample region of IBC mode and Intra TMP mode are aligned or are the same or are unified.

In another embodiment, reference sample region of IBC mode and Intra TMP mode in OBMC process are aligned or are the same or are unified.

In another embodiment, reference sample region of IBC mode and Intra TMP mode are aligned or are the same or are unified in other prediction modes.

In another embodiment, reference sample region of IBC mode and IntraTMP mode are non-overlapped.

### Current Motion and Neighbouring Motion for Current Block Region Validity Check

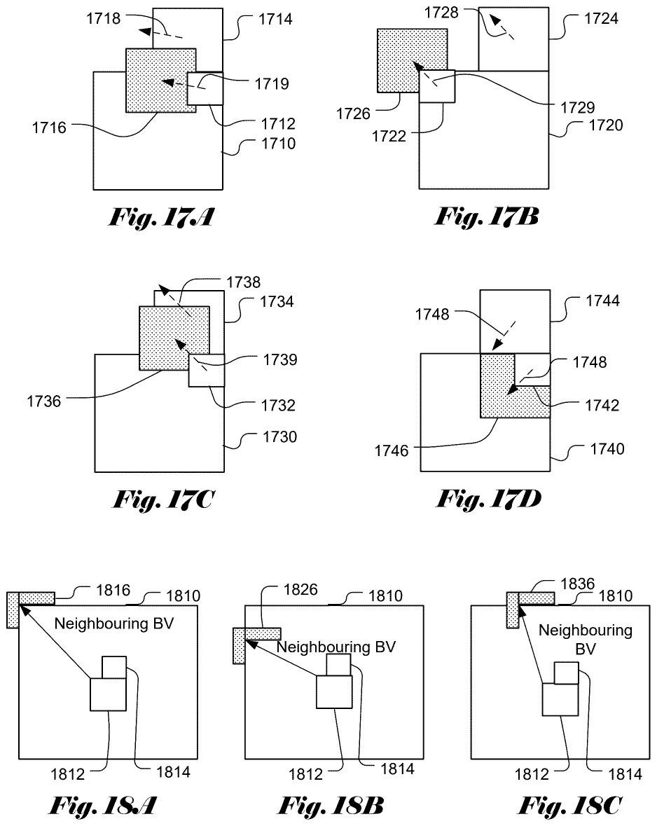

When block is IBC coded or IntraTMP coded, OBMC and TM-based OBMC is applied with the neighbouring motion or current motion for the current block region validity check, as shown in FIG. 16A-FIG. 16D for four different neighbouring BVs. When the reference block or reference template referenced by the neighbouring motion or current motion is determined to be invalid or unavailable, padding may be applied to those invalid or unavailable region in the reference block.

In one embodiment, when the neighbouring motion references any samples inside the current block (FIG. 16D), the neighbouring motion is determined to be invalid or unavailable in OBMC process. In FIG. 16D, block 1640 corresponds to the current block and block 1642 corresponds to a neighbouring block. BV 1646 of the neighbouring block is used as the BV 1648 by the current block to locate a reference block 1644.

In another embodiment, when only the bottom part of the reference block referenced by the neighbouring motion lies inside the current block (FIG. 16C), the neighbouring motion is determined to be invalid or unavailable in OBMC process. The OBMC process is skipped at the current subblock or current block. In FIG. 16C, block 1630 corresponds to the current block and block 1632 corresponds to a neighbouring block. BV 1636 of the neighbouring block is used as the BV 1638 by the current block to locate a reference block 1634.

In another embodiment, when only the bottom part of reference block referenced by the neighbouring motion lies inside the current block (left-bottom figure in FIG. 16C), the neighbouring motion is determined to be invalid or unavailable in OBMC process. For the overlapping current block region in the reference block, the reference samples are replaced with padding samples.

In another embodiment, when only the bottom part of the reference block referenced by the neighbouring motion lies inside the current block (FIG. 16C), only the horizontal part of the neighbouring motion is used in OBMC process.

In another embodiment, when only the right part of the reference block referenced by the neighbouring motion lies inside the current block (FIG. 16A), the neighbouring motion is determined to be invalid or unavailable in OBMC process. The OBMC process is skipped at the current subblock or current block. In FIG. 16A, block 1610 corresponds to the current block and block 1612 corresponds to a neighbouring block. BV 1616 of the neighbouring block is used as the BV 1618 by the current block to locate a reference block 1614.

In another embodiment, when only the right part of the reference block referenced by the neighbouring motion lies inside the current block (FIG. 16A), the neighbouring motion is determined to be invalid or unavailable in OBMC process. For the overlapping current block region in the reference block, the reference samples are replaced with padding samples.

In another embodiment, when only right part of reference block referenced by the neighbouring motion lies inside the current block (FIG. 16A), only the vertical part of neighbouring motion is used in OBMC process.

In another embodiment, when only the right-bottom part of the reference block referenced by the neighbouring motion lies inside the current block (FIG. 16B), the neighbouring motion is determined to be invalid or unavailable in OBMC process. The OBMC process is skipped for the current subblock or current block. In FIG. 16B, block 1620 corresponds to the current block and block 1622 corresponds to a neighbouring block. BV 1626 of the neighbouring block is used as the BV 1628 by the current block to locate a reference block 1624.

In another embodiment, when only the right-bottom part of the reference block referenced by the neighbouring motion lies inside the current block (FIG. 16B), the neighbouring motion is determined to be invalid or unavailable in OBMC process. For the overlapping current block region in the reference block, the reference samples are replaced with padding samples.

In another embodiment, when TM-based OBMC performs, reference templates from current motion and neighbouring motion are used. When the reference template overlaps with the current block region, the motion is determined to be invalid or unavailable in OBMC process. The OBMC process is skipped at the current subblock or current block.

In another embodiment, when TM-based OBMC performs, reference templates from the current motion and neighbouring motion are used. When the reference template overlaps with the current block region, the overlapped region in reference template is padded with available samples, and OBMC process uses the padded reference template to perform template matching operation.

### Subblock-Level Current Motion and Neighbouring Motion for Current Block Region Validity Check

When a block is IBC coded or IntraTMP coded, OBMC and TM-based OBMC is applied to each subblock inside with the neighbouring motion or current motion for the current block region validity check at current subblock position, as shown in FIG. 17A-FIG. 17D. When the reference block or reference template referenced by the neighbouring motion or current motion is determined to be invalid or unavailable, padding may be applied to those invalid or unavailable region in the reference block.

In one embodiment, when the neighbouring motion for the current subblock position references any samples inside the current block (FIG. 17D), the neighbouring motion at current subblock position is determined to be invalid or unavailable in OBMC process. In FIG. 17D, block 1740 corresponds to the current block and block 1744 corresponds to a neighbouring block. Subblock 1742 corresponds to a current subblock of current block 1740. BV 1748 of the neighbouring block is used as the BV 1749 by the current subblock 1742 to locate a reference block 1746.

In another embodiment, when only bottom part of reference block referenced by the neighbouring motion at current subblock position lies inside the current block (FIG. 17C), the neighbouring motion at current subblock position is determined to be invalid or unavailable in OBMC process. The OBMC process is skipped at current subblock or current block. In FIG. 17C, block 1730 corresponds to the current block and block 1734 corresponds to a neighbouring block. Subblock 1732 corresponds to a current subblock of current block 1730. BV 1738 of the neighbouring block is used as the BV 1739 by the current subblock 1732 to locate a reference block 1736.

In another embodiment, when only bottom part of reference block referenced by the neighbouring motion at current subblock position lies inside the current block (FIG. 17C), the neighbouring motion at current subblock position is determined to be invalid or unavailable in OBMC process. For the overlapping current block region in reference block, the reference samples are replaced with padding samples.

In another embodiment, when only bottom part of reference block referenced by the neighbouring motion at current subblock position lies inside the current block (FIG. 17C), only the horizontal part of neighbouring motion at current subblock position is used in OBMC process.

In another embodiment, when only right part of reference block referenced by the neighbouring motion at current subblock position lies inside the current block (FIG. 17A), the neighbouring motion at current subblock position is determined to be invalid or unavailable in OBMC process. The OBMC process is skipped at current subblock or current block. In FIG. 17A, block 1710 corresponds to the current block and block 1714 corresponds to a neighbouring block. Subblock 1712 corresponds to a current subblock of current block 1710. BV 1718 of the neighbouring block is used as the BV 1719 by the current subblock 1712 to locate a reference block 1716.

In another embodiment, when only right part of reference block referenced by the neighbouring motion at current subblock position lies inside the current block (FIG. 17A), the neighbouring motion at current subblock position is determined to be invalid or unavailable in OBMC process. For the overlapping current block region in the reference block, the reference samples are replaced with padding samples.

In another embodiment, when only right part of reference block referenced by the neighbouring motion at current subblock position lies inside the current block (FIG. 17A), only the vertical part of neighbouring motion at current subblock position is used in OBMC process.

In another embodiment, when only the right-bottom part of reference block referenced by the neighbouring motion at current subblock position lies inside the current block (FIG. 17B) the neighbouring motion at current subblock position is determined to be invalid or unavailable in OBMC process. The OBMC process is skipped at current subblock or current block. In FIG. 17B, block 1720 corresponds to the current block and block 1724 corresponds to a neighbouring block. Subblock 1722 corresponds to a current subblock of current block 1720. BV 1728 of the neighbouring block is used as the BV 1729 by the current subblock 1722 to locate a reference block 1726.

In another embodiment, when only the right-bottom part of reference block referenced by the neighbouring motion at current subblock position lies inside the current block (FIG. 17B), the neighbouring motion at current subblock position is determined to be invalid or unavailable in OBMC process. For the overlapping current block region in the reference block, the reference samples are replaced with padding samples.

In another embodiment, when TM-based OBMC is performed, the reference templates from the current motion and neighbouring motion are used. When the reference template overlaps with the current block region or current subblock region, the motion is determined to be invalid or unavailable in OBMC process. The OBMC process is skipped at the current subblock or current block.

In another embodiment, when TM-based OBMC is performed, the reference templates from the current motion and neighbouring motion are used. When the reference template overlaps with the current block region or current subblock region, the overlapped region in the reference template is padded with available samples, and OBMC process uses the padded reference template to perform the template matching operation.

### Current Motion and Neighbouring Motion Out-of-Picture Boundary Check

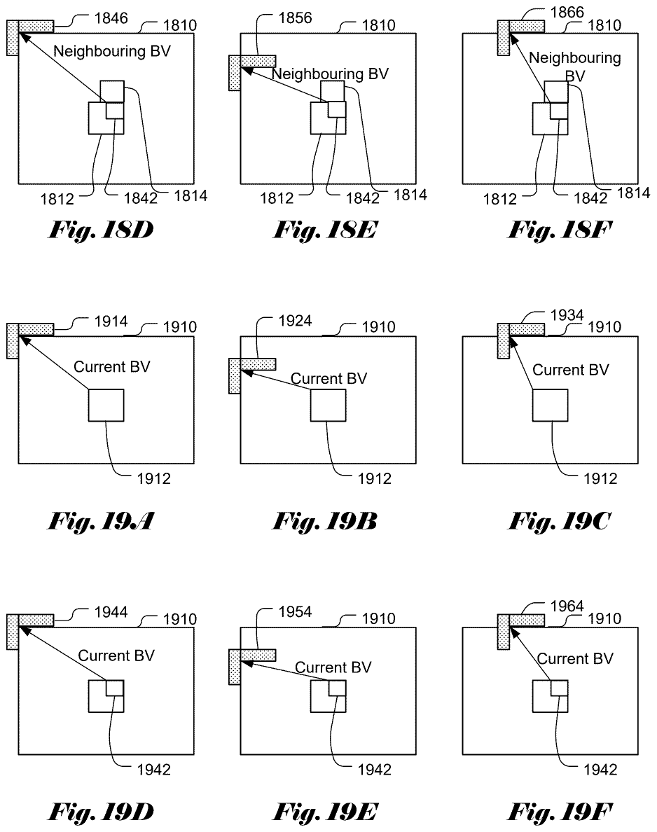

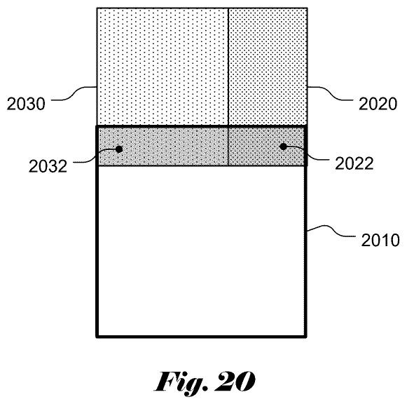

When the neighbouring block is IBC coded or IntraTMP coded, OBMC and TM-based OBMC are applied with neighbouring motion for out-of-picture boundary check, as shown in FIG. 18A-FIG. 18E. When the current block is IBC coded or IntraTMP coded, OBMC and TM-based OBMC are applied with the current motion for out-of-picture boundary check, as shown in FIG. 19A-FIG. 19E.

In one embodiment, when template-matching is performed using the neighbouring motion at the current block, the reference template is checked if the reference template is out-of-picture boundary as shown in FIG. 18A-FIG. 18C. In FIG. 18A-FIG. 18C, current block 1812 in current picture 1810 uses Neighbouring BV from neighbouring block 1814. A corresponding template (1816, 1826 or 1836) is located according to the Neighbouring BV. If the reference template is fully out-of-picture boundary (FIG. 18A), TM-based OMBC or other template-matching-based process will be skipped or fall back to some default settings or change to other modes.

In another embodiment, when template-matching is performed using the neighbouring motion at the current block, the reference template is checked if reference template is out-of-picture boundary. If only the left part of reference template is out-of-picture boundary (FIG. 18B), TM-based OMBC or other template-matching-based process will be skipped or fall back to some default settings or change to other modes.

In another embodiment, when template-matching is performed using the neighbouring motion at the current block, the reference template is checked if reference template is out-of-picture boundary. If only the top part of reference template is out-of-picture boundary (FIG. 18C), TM-based OMBC or other template-matching-based process will be skipped or fall back to some default settings or change to other modes.

In another embodiment, when the template-matching is performed using the neighbouring motion at the current subblock, the reference template is checked if reference template is out-of-picture boundary as shown in FIG. 18D-FIG. 18F. In FIG. 18D-FIG. 18F, current subblock 1842 uses Neighbouring BV from neighbouring block 1814. A corresponding template (1846, 1856 or 1866) is located according to the Neighbouring BV. If the reference template is out-of-picture boundary totally (FIG. 18D), TM-based OMBC or other template-matching-based process will be skipped or fall back to some default settings or change to other modes.

In another embodiment, when the template-matching is performed using the neighbouring motion at the current subblock, the reference template is checked if the reference template is out-of-picture boundary. If only the left part of reference template is out-of-picture boundary (FIG. 18E), TM-based OMBC or other template-matching-based process will be skipped or fall back to some default settings or change to other modes.

In another embodiment, when the template-matching is performed using the neighbouring motion at the current subblock, the reference template is checked if the reference template is out-of-picture boundary. If only the top part of reference template is out-of-picture boundary (FIG. 18F), TM-based OMBC or other template-matching-based process will be skipped or fall back to some default settings or change to other modes.

In another embodiment, when template-matching is performed using the current motion at the current block as shown in FIG. 19A-FIG. 19C, the reference template is checked if the reference template is out-of-picture boundary. In FIG. 19A-FIG. 19C, Current BV of current block 1912 in current picture 1910 is used to locate a corresponding template (1914, 1924 or 1934). If the reference template is out-of-picture boundary totally (FIG. 19A), TM-based OMBC or other template-matching-based process will be skipped or fall back to some default settings or change to other modes.

In another embodiment, when template-matching is performed using the current motion at the current block, the reference template is checked if the reference template is out-of-picture boundary. If only the left part of reference template is out-of-picture boundary (FIG. 19B), TM-based OMBC or other template-matching-based process will be skipped or fall back to some default settings or change to other modes.

In another embodiment, when template-matching is performed using the current motion at the current block, the reference template is checked if the reference template is out-of-picture boundary. If only the top part of reference template is out-of-picture boundary (FIG. 19C), TM-based OMBC or other template-matching-based process will be skipped or fall back to some default settings or change to other modes.

In another embodiment, when template-matching is performed using the current motion at the current subblock as shown in FIG. 19D-FIG. 19F, the reference template is checked if the reference template is out-of-picture boundary. In FIG. 19D-FIG. 19F, Current BV of current subblock 1942 in current picture 1910 is used to locate a corresponding template (1944, 1954 or 1964). If the reference template is out-of-picture boundary totally (FIG. 19D), TM-based OMBC or other template-matching-based process will be skipped or fall back to some default settings or change to other modes.

In another embodiment, when template-matching is performed using the current motion at the current subblock, the reference template is checked if the reference template is out-of-picture boundary. If only the left part of reference template is out-of-picture boundary (FIG. 19E), TM-based OMBC or other template-matching-based process will be skipped or fall back to some default settings or change to other modes.

In another embodiment, when template-matching is performed using the current motion at the current subblock, the reference template is checked if the reference template is out-of-picture boundary. If only the top part of reference template is out-of-picture boundary (FIG. 19F), TM-based OMBC or other template-matching-based process will be skipped or fall back to some default settings or change to other modes.

In another embodiment, when the current motion from IBC mode or IntraTMP mode is used at the current block, the motion is checked if it exceeds the picture boundary or the reference samples exceeds the picture boundary. If the motion exceeds the picture boundary, OBMC process will be skipped or fall back to some default settings or change to other modes.

In another embodiment, when the neighbour motion from IBC mode or IntraTMP mode is used at the current block, the motion is checked if it exceeds the picture boundary or the reference samples exceeds the picture boundary. If the motion exceeds the picture boundary, OBMC process will be skipped or fall back to some default settings or change to other modes.

In another embodiment, when the current motion from IBC mode or IntraTMP mode is used at the current subblock, the motion is checked if it exceeds the picture boundary or the reference samples exceeds the picture boundary. If the motion exceeds the picture boundary, OBMC process will be skipped or fall back to some default settings or change to other modes.

In another embodiment, when the neighbour motion from IBC mode or IntraTMP mode is used at the current subblock, the motion is checked if it exceeds the picture boundary or the reference samples exceeds the picture boundary. If the motion exceeds the picture boundary, OBMC process will be skipped or fall back to some default settings or change to other modes.

### OBMC in LMCS Reshaped Domain and Original Domain

When the neighbouring block or current block is coded with IBC mode or IntraTMP mode, the generated predictor will be from the current picture in the reshaped domain, and the inter-predictor from inter-motion will be from the reference picture in the original domain, when LMCS is enabled or the predictor is converted into reshaped domain.

In one embodiment, predictors from IBC mode or IntraTMP mode are in the reshaped domain, and predictors from inter-prediction modes are in the original domain, and OBMC process directly blends these predictors in different domains.

In another embodiment, predictors from IBC mode or IntraTMP mode are in the reshaped domain, and predictors from inter-prediction modes are in the original domain, predictors are all converted into original domain and OBMC process performs in the original domain.

In another embodiment, predictors from IBC mode or IntraTMP mode are in the reshaped domain, and predictors from inter-prediction modes are in the original domain, predictors are all converted into reshaped domain and OBMC process performs in the reshaped domain.

In another embodiment, OBMC process is performed in the reshaped domain in I-slice and original domain in P-slice and B-slice.

In another embodiment, OBMC process is always performed in the reshaped domain regardless of picture types.

In another embodiment, OBMC process is always performed in the original domain regardless of picture types.

In another embodiment, the domain in which OBMC process performs depends on current block's info, such as prediction mode or reference pictures.

In another embodiment, the domain in which OBMC process performs depends on neighbour block's information, such as prediction mode or reference pictures.

In another embodiment, the reference template in TM-based OBMC is in the reshaped domain in I-slice, in the original domain in P-slice and B-slice.

In another embodiment, the reference template in TM-based OBMC is in the reshaped domain regardless of picture types.

In another embodiment, the reference template in TM-based OBMC is in the original domain regardless of picture types.

In another embodiment, the domain in which the reference template in TM-based OBMC lies depends on current block's information, such as prediction mode or reference pictures.

In another embodiment, the domain in which the reference template in TM-based OBMC lies depends on neighbouring block's information, such as prediction mode or reference pictures.

In another embodiment, the domain in which OBMC is performed depends on some flags, such as CU-level flag, CTU-level flag, picture-level flag or sequence-level flag.

In another embodiment, the domain in which reference template in TM-based OBMC lies depends on some flags, such as CU-level flag, CTU-level flag or picture-level flag, sequence-level flag.

### Neighbouring Motion Constraint

In proposed method, when neighbouring block is coded in IBC mode or IntraTMP mode, OBMC process is performed with BVs to refine current block's predictor. But some kinds of motion in IBC mode or IntraTMP mode may not be allowed in OBMC process.

In one embodiment, when the current block or neighbouring block is coded in IBC-LIC mode, OBMC is skipped or terminated or falls back to some default setting at the current block or current subblock.

In another embodiment, when the current block or neighbouring block is coded in IBC-GPM mode, OBMC is skipped or terminated or falls back to some default setting at the current block or current subblock.

In another embodiment, when the current block or neighbouring block is coded in IBC-CIIP mode, OBMC is skipped or terminated or falls back to some default setting at the current block or current subblock.

In another embodiment, when the current block or neighbouring block is coded in IBC-MBVD mode, OBMC is skipped or terminated or falls back to some default setting at the current block or current subblock.

In one embodiment, when the current block or neighbouring block is coded in RR-IBC mode, OBMC is skipped or terminated or falls back to some default setting at the current block or current subblock.

In another embodiment, when the current block or neighbouring block is coded in RR-IntraTMP mode, OBMC is skipped or terminated or falls back to some default setting at the current block or current subblock.

In another embodiment, when the current block or neighbouring block is coded in bi-predictive IBC mode, OBMC is skipped or terminated or falls back to some default setting at the current block or current subblock.

In another embodiment, when the current block or neighbouring block is coded in bi-predictive IBC mode, bi-prediction BVs are converted to uni-prediction in OBMC process.

In another embodiment, when the current block or neighbouring block is coded in IBC mode with fractional-pel BV, fractional-pel BV is converted to integer-pel BV in OBMC process.

In another embodiment, when the current block or neighbouring block is coded in IBC mode with fractional-pel BV, fractional-pel BV is used in OBMC process.

In another embodiment, temporal BV is used in OBMC process.

### Subblock-Based Blending Weightings and Blending Lines Decision in TM-Based OBMC

In ECM OBMC, consecutive same neighbouring motions in several subblocks will be grouped together to perform motion compensation to generate neighbouring predictors for blending in OBMC process. The same process is also performed in TM-based OBMC, but it constrains multiple subblocks to have same template-matching decision, i.e., same blending lines and blending weightings for multiple subblocks. In the proposed method, these multiple subblocks may have different template-matching decisions, resulting in different blending lines or blending weightings.

In one embodiment, in CU-boundary OBMC, consecutive same neighbouring motions in several subblocks are grouped together, but when they perform template-matching decision, each subblock can have its own template matching decision, i.e., blending lines or blending weightings.

In another embodiment, in CU-boundary OBMC, each subblock in current block performs motion compensation separately, and each subblock has its own template matching decision, i.e., blending lines or blending weightings.

In another embodiment, in CU-boundary OBMC, when the current block is in the subblock mode or affine mode, when OBMC checks motion similarity between the current subblock position and neighbouring block position, consecutive motion depends on not only the neighbouring block motion but also the current subblock motion.

Only when both the neighbouring motion and current subblock motion have consecutive motion, subblocks can be grouped together.

In the present invention, several new methods of OBMC in IBC mode and IntraTMP mode are disclosed. When current block's BV is in fractional-pel precision, motion validity check and OBMC are performed.

When the current block or neighbouring block is coded in IBC related prediction mode, including but not limited to, IBC-GPM, IBC-LIC, IBC-CIIP mode, OBMC is performed.

In OBMC, difference between current predictor and neighbouring integer-pel interpolated predictor will be calculated and OBMC process may be skipped if the difference exceeds a threshold. In the proposed method, similar process may be applied to OBMC in IBC mode or IntraTMP mode.

In OBMC, consecutive same motion will be grouped together to perform neighbouring predictor generation, where the same motion can be the same MV in neighbouring blocks or subblocks and/or same MV in current blocks or subblocks. The same motion can be with or without other constraints, such as same reference index or same inter-prediction direction.

### Fractional-Pel BV in OBMC and Motion Validity Check

In one embodiment, motion validity check, as shown in FIG. 16A-FIG. 16D, FIG. 17A-FIG. 17D, FIG. 18A-FIG. 18F and FIG. 19A-FIG. 19F, fractional-pel precision BV can be taken into consideration. For example, the overlapped region between the current block and reference block can be fractional-pel in FIG. 16A-FIG. 16D and FIG. 17A-FIG. 17D. Similarly, for template-matching-based OBMC, fractional-pel BV is also considered, as shown in FIG. 18A-FIG. 18F and FIG. 19A-FIG. 19F.

### Interpolation Filter Inheritance in OBMC in IBC Mode and IntraTMP Mode

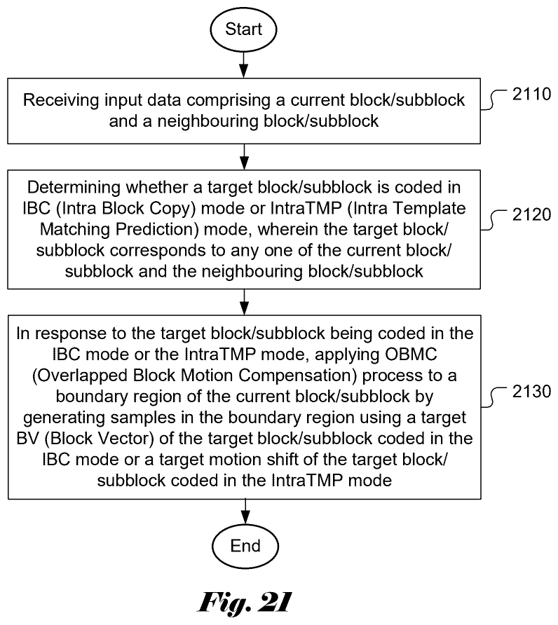

In one embodiment, when generating the neighbouring predictor in OBMC, neighbouring blocks' IMV information or neighbouring interpolation filter information is used, as shown in FIG. 20. The IMV represents an indicator associated with MV resolution (e.g. AMVR (Adaptive MV Resolution) precision). In FIG. 20, block 2010 corresponds to the current block and blocks 2020 and 2030 are two neighbouring blocks on the top side of the current block. The boundary region 2022 between current block 2010 and neighbouring block 2020 uses IMV of neighbouring block 2020. Similarly, the boundary region 2032 between current block 2010 and neighbouring block 2030 uses IMV of neighbouring block 2030.

In another embodiment, when generating the neighbouring prediction in OBMC, current block's IMV information or current interpolation filter information is used.

### OBMC Support in IBC-MBVD, IBC-GPM, IBC-LIC and IBC-CIIP Mode

In one embodiment, OBMC process in IBC-GPM is aligned with other OBMC process in GPM mode.

In another embodiment, OBMC process in IBC-LIC is aligned with other OBMC process in LIC mode.

In another embodiment, OBMC process in IBC-CIIP mode is aligned with other OBMC process in CIIP mode.

In another embodiment, OBMC process in IBC-MBVD mode is aligned with other OBMC process in MMVD mode.

In another embodiment, OBMC process in IBC-CIIP is firstly performed to refine the IBC-predictor before intra-predictor blending process.

In another embodiment, OBMC process in IBC-CIIP is performed after IBC-predictor blending with intra-predictor.

In another embodiment, OBMC process in IBC-GPM is firstly performed to refine IBC-predictor before intra-predictor blending process.

In another embodiment, OBMC process in IBC-GPM is performed after IBC-predictor blending with intra-predictor.

In another embodiment, OBMC process performed in IBC-LIC process depends on current block's IBC-LIC flag.

In another embodiment, OBMC process performed in IBC-LIC process depends on neighbouring block's IBC-LIC flag.

In another embodiment, LIC parameters are inherited from neighbouring block's LIC parameters when OBMC depends on neighbouring block's IBC-LIC flag.

In another embodiment, LIC parameters are inherited from current block's LIC parameters when OBMC depends on current block's IBC-LIC flag.

### Block Boundary OBMC Skip

In one embodiment, for block boundary OBMC skip, the current picture is used as the reference picture in IBC mode and IntraTMP mode.

In another embodiment, same threshold as in inter-prediction mode or different threshold from inter-prediction mode is used in block boundary OBMC skip.

In another embodiment, integer-pel or fractional-pel BV is used to generate the neighbouring predictor in OBMC process in block boundary OBMC skip.

### Consecutive Same BV in OBMC

In one embodiment, consecutive same BVs are grouped together to generate neighbouring predictors. The same BV can be the neighbouring BV with the same magnitude or with the same reference index or with the same inter-prediction direction. The same BV may further correspond to the same LIC flag or same LIC parameters.

In another embodiment, consecutive same BVs may further take into account current block's same BV. For example, not only neighbouring BVs are consecutively the same, but also current block's BV are consecutively the same at the current subblock.

### Chroma OBMC in P/B Slice in IBC Mode and IntraTMP Mode

In one embodiment, OBMC process for the chroma component is performed in B-slice and P-slice in IBC mode and IntraTMP mode.

In another embodiment, OBMC process for the chroma component is performed regardless of LMCS chroma scaling process.

In another embodiment, OBMC process for the chroma component is performed considering LMCS chroma scaling process.

### Syntax Design of OBMC in IBC Mode and IntraTMP Mode

In one embodiment, OBMC flag can be inferred to be true or false according to some constraints, including but not limited to, block area constraint, block width or block height constraint, block aspect ratio constraint.

In another embodiment, OBMC flag is always true in IBC merge mode, but OBMC process may be disabled according to block size constraint.

In another embodiment, OBMC flag can be true or false in IBC merge mode.

In another embodiment, OBMC flag is always true in IBC AMVP mode, but OBMC process may be disabled according to block size constraint.

In another embodiment, OBMC flag can be true or false in IBC AMVP mode.

In another embodiment, OBMC flag can be inherited from neighbouring IBC coded block or IntraTMP coded block.

In another embodiment, current block inherits either OBMC flag or IBC-LIC flag.

In another embodiment, OBMC flag and IBC-LIC flag is mutually exclusive inherited.

In another embodiment, OBMC flag is inherited only from certain prediction modes, such as IBC-MBVD mode, IBC-CIIP mode or IBC-GPM mode.

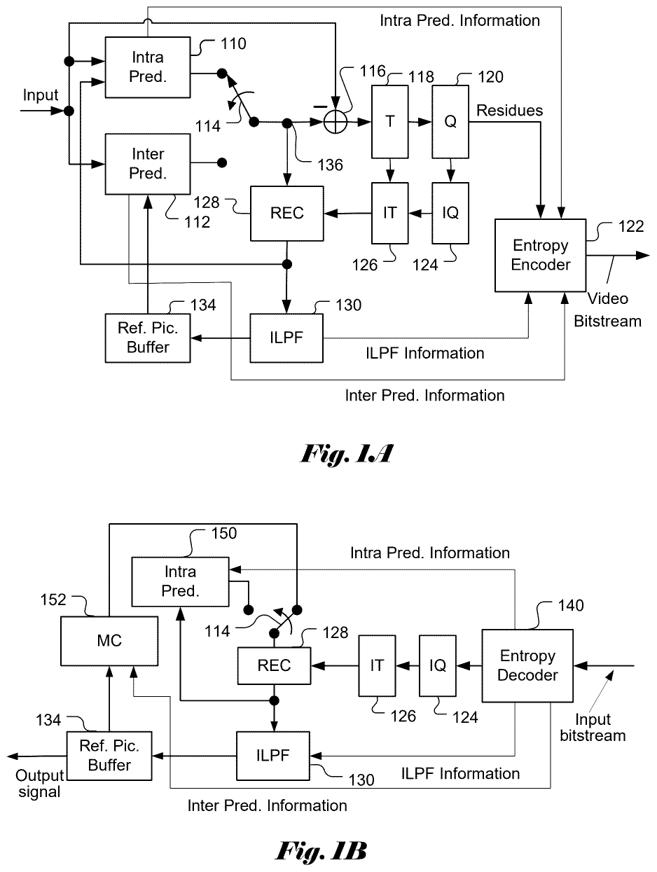

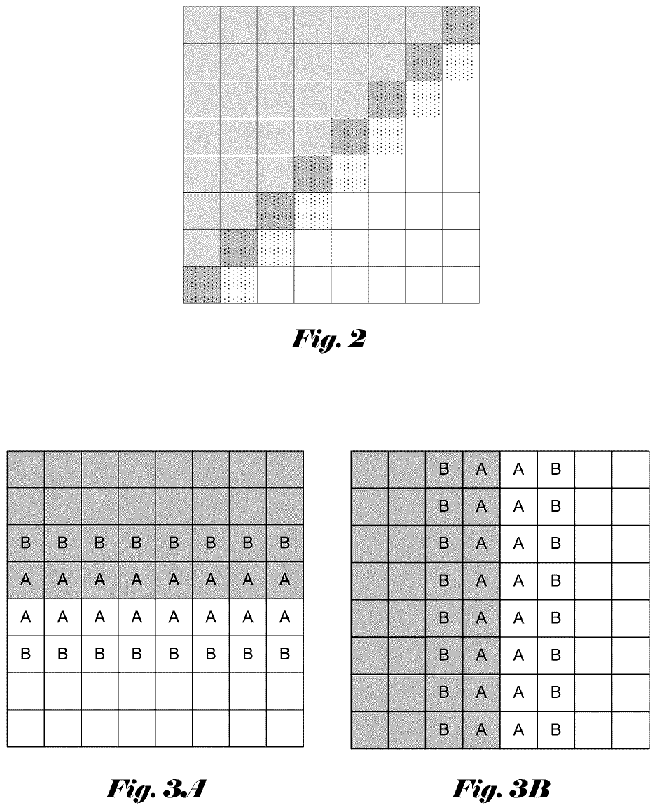

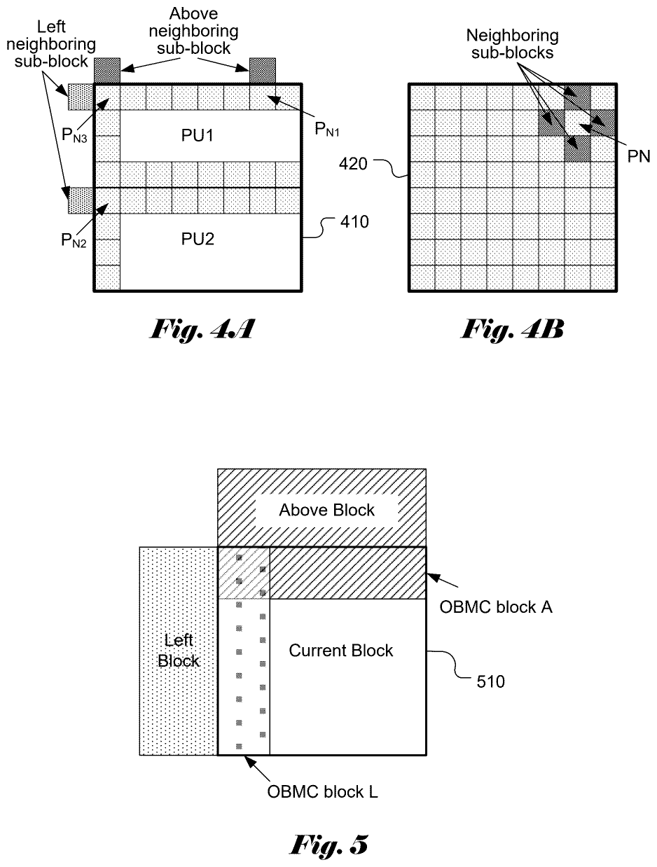

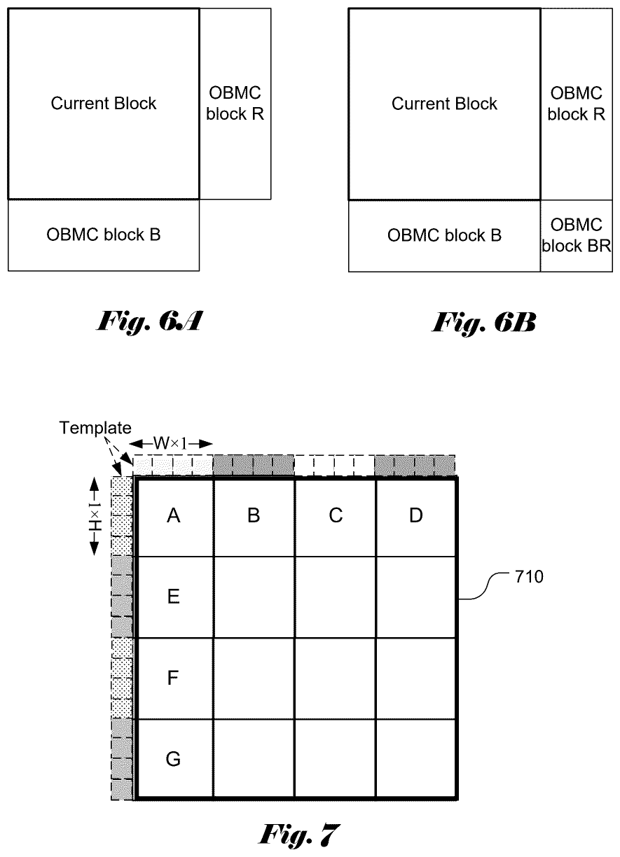

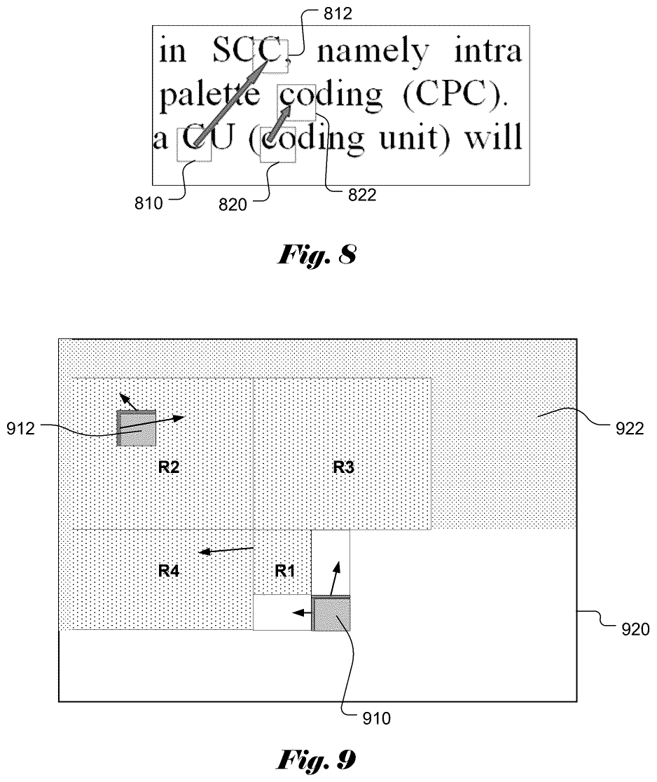

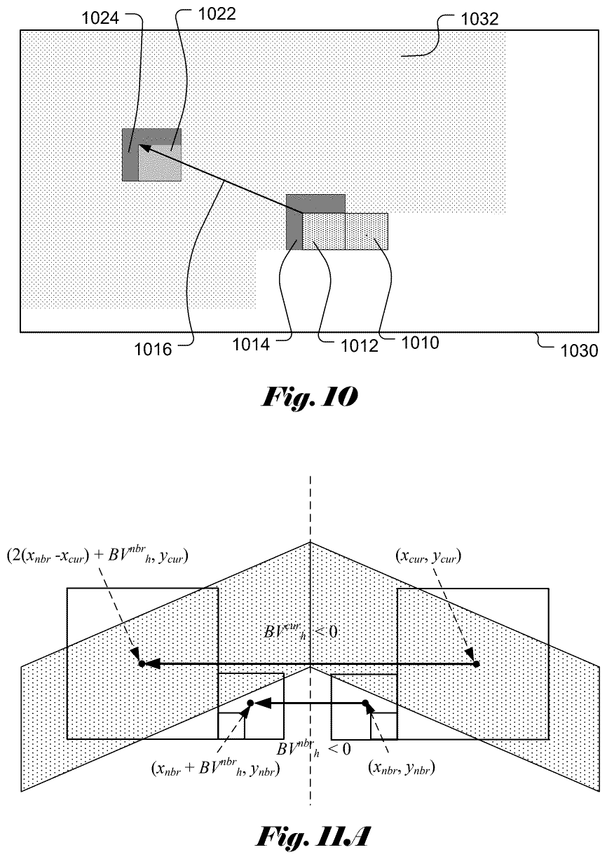

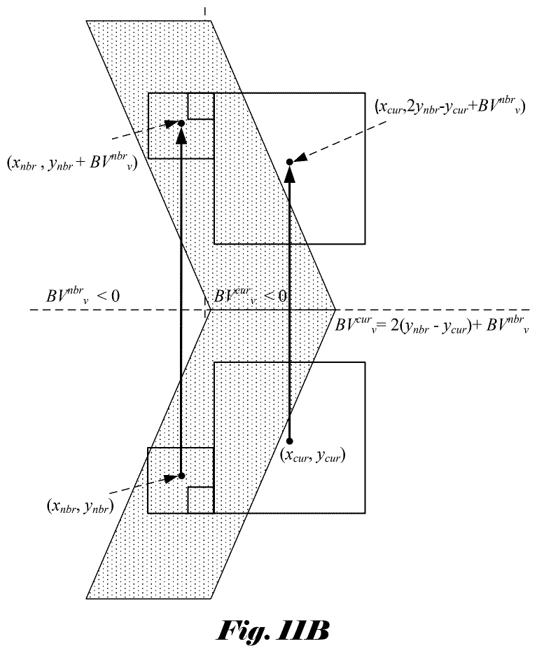

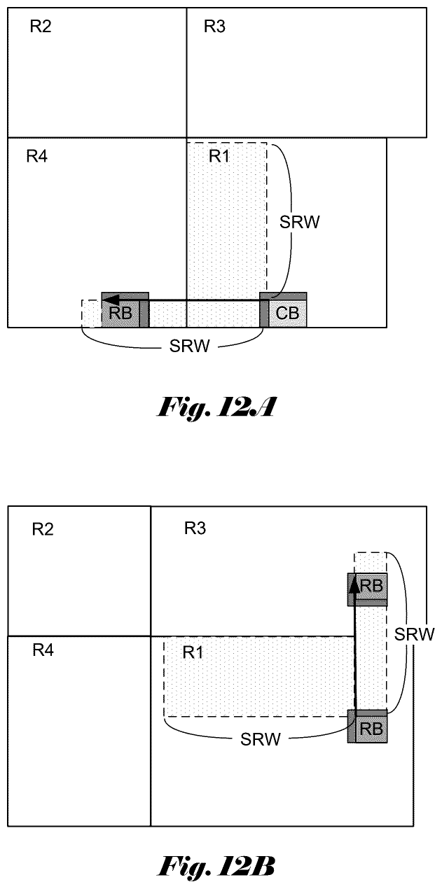

Any of the foregoing proposed OBMC for IBC or IntraTMP coded blocks can be implemented in encoders and/or decoders. For example, any of the proposed methods can be implemented in a predictor derivation module of an encoder, and/or a predictor derivation module of a decoder. Alternatively, any of the proposed methods can be implemented as a circuit coupled to the predictor derivation module of the encoder and/or the predictor derivation module of the decoder, so as to provide the information needed by the predictor derivation module. For example, the OBMC for IBC or IntraTMP coded blocks can be implemented in an encoder side or a decoder side, such as the Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A).

FIG. 21 illustrates a flowchart of an exemplary video coding system, where the OBMC process is applied to boundaries of IBC or IntraTMP coded blocks according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data comprising a current block/subblock and a neighbouring block/subblock are received in step 2110. Whether a target block/subblock is coded in IBC (Intra Block Copy) mode or IntraTMP (Intra Template Matching Prediction) mode is determined in step 2120, wherein the target block/subblock corresponds to any one of the current block/subblock and the neighbouring block/subblock. In response to the target block/subblock being coded in the IBC mode or the IntraTMP mode, OBMC (Overlapped Block Motion Compensation) process is applied to a boundary region of the current block/subblock by generating samples in the boundary region using a target BV (Block Vector) of the target block/subblock coded in the IBC mode or a target motion shift of the target block/subblock coded in the IntraTMP mode in step 2130.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data comprising a current block/subblock and a neighbouring block/subblock;
determining whether a target block/subblock is coded in IBC (Intra Block Copy) mode or IntraTMP (Intra Template Matching Prediction) mode, wherein the target block/subblock corresponds to any one of the current block/subblock and the neighbouring block/subblock; and
in response to the target block/subblock being coded in the IBC mode or the IntraTMP mode, applying OBMC (Overlapped Block Motion Compensation) process to a boundary region of the current block/subblock by generating samples in the boundary region using a target BV (Block Vector) of the target block/subblock coded in the IBC mode or a target motion shift of the target block/subblock coded in the IntraTMP mode.

2. The method of claim 1, wherein when the target block/subblock corresponds to the neighbouring block/subblock coded in the IBC mode, the target BV, a horizontal component of the target BV or a vertical component of the target BV is used for the OBMC process.

3. The method of claim 2, wherein the target block corresponds to the current block/subblock coded in the IBC mode.

4. The method of claim 1, wherein when the target block/subblock corresponds to the neighbouring block/subblock coded in the IBC mode, an average BV is used for the OBMC process, and wherein the average BV corresponds to an average of the target BV and a current MV (Motion Vector) of the current block/subblock.

5. The method of claim 1, wherein when the target block/subblock corresponds to the neighbouring block/subblock coded in the IntraTMP mode, the target motion shift, a horizontal component of the target motion shift or a vertical component of the target motion shift is used for the OBMC process.

6. The method of claim 1, wherein when the target block/subblock corresponds to the neighbouring block/subblock coded in the IntraTMP mode, an average motion shift is used for the OBMC process, and wherein the average motion shift corresponds to an average of the target motion shift and a current MV (Motion Vector) of the current block/subblock.

7. The method of claim 1, wherein when the target block/subblock corresponds to the current block/subblock coded in the IBC mode, and the neighbouring block/subblock is coded in an inter-prediction mode, the target BV and motion vector of the neighbouring block/subblock are used for the OBMC process.

8. The method of claim 1, wherein when the target block/subblock corresponds to the current block/subblock coded in the IntraTMP mode, and the neighbouring block/subblock is coded in an inter-prediction mode, the target motion shift and motion vector of the neighbouring block/subblock are used for the OBMC process.

9. The method of claim 1, wherein when the target block/subblock corresponds to the neighbouring block/subblock coded in the IBC mode, and the current block/subblock is coded in an inter-prediction mode, the target BV and motion vector of the current block/subblock are used for the OBMC process.

10. The method of claim 1, wherein when the target block/subblock corresponds to the neighbouring block/subblock coded in the IntraTMP mode, and the current block/subblock is coded in an inter-prediction mode, the target motion shift and motion vector of the current block/subblock are used for the OBMC process.

11. The method of claim 1, wherein when the target block/subblock corresponds to the current block/subblock coded in the IBC mode, and the neighbouring block/subblock is coded in the IntraTMP mode, the target BV and motion shift of the neighbouring block/subblock are used for the OBMC process.

12. The method of claim 1, wherein when the target block/subblock corresponds to the current block/subblock coded in the IntraTMP mode, and the neighbouring block/subblock is coded in the IBC mode, the target motion shift and block vector of the neighbouring block/subblock are used for the OBMC process.

13. The method of claim 1, wherein when both the current block/subblock and the neighbouring block/subblock are coded in the IBC mode, both block vectors of the current block/subblock and the neighbouring block/subblock are used for the OBMC process.

14. The method of claim 1, wherein when both the current block/subblock and the neighbouring block/subblock are coded in the IntraTMP mode, both motion shifts of the current block/subblock and the neighbouring block/subblock are used for the OBMC process.

15. An apparatus for video coding, the apparatus comprising one or more electronics or processors arranged to:
receive input data comprising a current block/subblock and a neighbouring block/subblock;
determine whether a target block/subblock is coded in IBC (Intra Block Copy) mode or IntraTMP (Intra Template Matching Prediction) mode, wherein the target block/subblock corresponds to any one of the current block/subblock and the neighbouring block/subblock; and
in response to the target block/subblock being coded in the IBC mode or the IntraTMP mode, apply OBMC (Overlapped Block Motion Compensation) process to a boundary region of the current block/subblock by generating samples in the boundary region using a target BV (Block Vector) of the target block/subblock coded in the IBC mode or a target motion shift of the target block/subblock coded in the IntraTMP mode.
